(19) United States
(12) Patent Application Publication
(10) Pub. No.: US 2022/0270067 A1
(43) Pub. Date: Aug. 25, 2022

(54) TRANSACTION DATA PROCESSING METHOD, DEVICE, APPARATUS AND SYSTEM

(71) Applicant: NETSUNION CLEARING CORPORATION, Beijing (CN)

(72) Inventors: Xiang Lu, Beijing (CN); Wenhan Zhang, Beijing (CN); Peng Zhang, Beijing (CN)

(21) Appl. No.: 17/620,482

(22) PCT Filed: Jun. 24, 2020
(86) PCT No.: PCT/CN2020/098151

§ 371 Date: Dec. 17, 2021

(30) Foreign Application Priority Data
Jun. 27, 2019 (CN) 201910572783.3
Aug. 5, 2019 (CN) 201910716548.9
Feb. 28, 2020 (CN) 202010133528.1

(51) Int. Cl. G06Q 20/22; G06Q 20/40; G06Q 20/38; G06Q 20/02

(52) U.S. Cl. CPC G06Q 20/227; G06Q 20/403; G06Q 20/382; G06Q 20/02

(57) ABSTRACT

The present disclosure relates to the field of Internet technology. A transaction data processing method, a transaction data processing apparatus, a transaction data processing system, an electronic device, and a computer readable storage medium are provided. The method comprises: creating multiple data centers (301); with respect to at least two data centers in the multiple data centers, creating corresponding second-level accounts for a target payment institution respectively, wherein the second-level accounts support resource requirements of any third-level account corresponding to the target payment institution in the data centers (302); determining an available data center among the at least two data centers (303); and processing transaction data from the target payment institution by using a second-level account created for the target payment institution with respect to the available data center (304).

### CROSS-REFERENCES TO RELATED APPLICATION

The present application claims priority to Chinese patent application No. 201910572783.3 filed by NetsUnion Clearing Corporation on Jun. 27, 2019 and entitled “Transaction Data Processing Method and Device for Payment Institutions”, Chinese patent application No. 201910716548.9 filed by NetsUnion Clearing Corporation on Aug. 5, 2019 and entitled “Resource Allocation Method, Apparatus and Device of Multi-Level Accounts”, and Chinese patent application No. 202010133528.1 filed by NetsUnion Clearing Corporation on Feb. 28, 2020 and entitled “Dispatching Apparatus, Resource Allocation Method performed Thereby, and Distributed Processing System”.

### TECHNICAL FIELD

The present disclosure relates to the field of Internet technology, and more specifically, to a transaction data processing method, apparatus, device and system.

### BACKGROUND

As shown in FIG. 1, although there are multiple transaction systems in the existing accounting system architecture, in order to solve the problem of data consistency, the account systems in the system architecture are typically a single account system or a primary-backup account system.

In the so-called single account system, only one account is created for a target payment institution, such as a payment institution, regardless of how many data centers there are in the transaction system. In the so-called primary-backup account system, two accounts, i.e., a primary account and a backup account, are created for a target payment institution. In the primary-backup account system, if the primary account is normal, only the master account is used to process the relevant data of the target payment institution; and if the primary account is abnormal, the backup account is used to process the relevant data of the target payment institution. In other words, the primary and backup accounts cannot be used at the same time. Thus, the existing accounting system architecture has the defects of high failure risk of single point and poor business continuity.

### SUMMARY

In view of this, the present disclosure provides a transaction data processing method, apparatus, device and system capable of improving business continuity.

An aspect of the present disclosure provides a transaction data processing method, which comprises:

creating multiple data centers;

with respect to at least two data centers in the multiple data centers, creating corresponding second-level accounts for a target payment institution respectively, wherein the second-level accounts support resource requirements of any third-level account corresponding to the target payment institution in the data centers;

determining an available data center among the at least two data centers; and

processing transaction data from the target payment institution by using a second-level account created for the target payment institution with respect to the available data center.

According to an embodiment of the present disclosure, the method further comprises: creating a corresponding first-level account for the target payment institution, wherein the first-level account is an upper-level account of all second-level accounts created with respect to the target payment institution;

creating an association relationship between the second-level accounts of the target payment institution and the first-level account of the target payment institution to obtain an account system of the target payment institution, wherein the association relationship includes that a resource amount in the first-level account and a resource amount in the second-level account are independent from each other and are mutually transferrable; and

controlling the transaction data to circulate in the account system during processing the transaction data of the target payment institution.

According to an embodiment of the present disclosure, controlling the transaction data to circulate in the account system comprises:

when a second-level account of the target payment institution corresponding to an available data center fails, using a second-level account of the target payment institution corresponding to any other available data center to process the transaction data of the target payment institution.

According to an embodiment of the present disclosure, controlling the transaction data to circulate in the account system comprises:

when a data center level resource amount of the target payment institution corresponding to an available data center is insufficient, using both a second-level account of the target payment institution corresponding to the available data center and a second-level account of the target payment institution corresponding to any other available data center to process the transaction data of the target payment institution.

According to an embodiment of the present disclosure, the method further comprises: creating at least one third-level account for each second-level account of the target payment institution.

According to an embodiment of the present disclosure, the method further comprises: creating transaction routes between different data centers to obtain a corresponding transaction system; and

during processing the transaction data of the target payment institution, when an available data center fails or is busy, using any other available data center in the transaction system to process the transaction data of the target payment institution.

According to an embodiment of the present disclosure, the method further comprises:

acquiring currently available second-level accounts, controlling the first-level account to evenly distribute resources to the currently available second-level accounts according to a number of the currently available second-level accounts;

acquiring a resource amount of a target third-level account, and matching the resource amount with a preset sub-account allocation amount;

when the resource amount is less than the sub-account allocation amount, controlling the target second-level account to which the target third-level account belongs to allocate resources to the target third-level account so that the resource amount of the target third-level account is equal to the sub-account allocation amount;

when the resource amount is greater than the sub-account allocation amount, controlling the target third-level account to turn in resources to the target second-level account so that the resource amount of the target third-level account is equal to the sub-account allocation amount.

According to an embodiment of the present disclosure, after controlling the target second-level account to which the target third-level account belongs to allocate resources to the target third-level account, the method further comprises:

detecting whether the target second-level account fails to allocate resources to the target third-level account;

if a resource allocation failure is detected, acquiring any other available second-level account;

controlling the any other available second-level account to allocate resources to the target third-level account.

According to an embodiment of the present disclosure, after controlling the target third-level account to turn in resources to the target second-level account, the method further comprises:

detecting whether the target third-level account fails to turn in resources to the target second-level account;

if a resource turning in failure is detected, acquiring any other available second-level account;

controlling the target third-level account to turn in resources to the any other available second-level account.

According to an embodiment of the present disclosure, the sub-account allocation amount=a total allocation amount/a number of currently available third-level accounts.

According to an embodiment of the present disclosure, the method further comprises: acquiring status of each second-level account in the multi-level accounts;

if it is known that status of a current second-level account is unavailable, turning in resources of the current second-level account to the first-level account.

According to an embodiment of the present disclosure, the method further comprises: acquiring status of each third-level account in the multi-level accounts;

if it is known that status of a current third-level account is unavailable, turning in resources of the current third-level account to the second-level account to which the current third-level account belongs;

if the second-level account to which the current third-level account belongs is unavailable, turning in resources of the current third-level account to any other available second-level account.

According to an embodiment of the present disclosure, the first data center is provided with a first-level account, the second data center is provided with m number of second-level accounts, the first-level account corresponds to the m number of second-level accounts, and the method further comprises:

determining a resource reference value with respect to the m number of second-level accounts according to m number of residual resource values of the m number of second-level accounts;

sending the resource reference value to the second data center to instruct the second data center to determine whether to send a redundant resource value of each second-level account provided therein;

receiving respective redundant resource values of n number of second-level accounts sent by the second data center to obtain n number of redundant resource values;

pushing the n number of redundant resource values to the first data center to instruct the first data center to determine an allocated resource value allocated to k number of second-level accounts in the m number of second-level accounts; and

sending the allocated resource value to the second data center to instruct the second data center to update the residual resource values of the k number of second-level accounts according to the allocated resource value;

where m, n and k are positive integers, n is less than m, and k is less than or equal to m.

According to an embodiment of the present disclosure, before determining the resource reference value with respect to the m number of second-level accounts, the method further comprises:

determining whether the m number of residual resource values meet a preset condition; and

when the m number of residual resource values meet the preset condition, determining the resource reference value with respect to the m number of second-level accounts.

According to an embodiment of the present disclosure, determining whether the m number of residual resource values meet the preset condition comprises:

determining an actual deviation degree and an actual deviation value of the m number of residual resource values; and

when the actual deviation degree is greater than a preset deviation degree and the actual deviation value is greater than a preset deviation value, determining that the m number of residual resource values meet the preset condition.

According to an embodiment of the present disclosure, the method further comprises:

instructing the second data center to do as follows: update respective residual resource values of the n number of second-level accounts when it is determined to send respective redundant resource values of the n number of second-level accounts; and

instructing the first data center to do as follows: update a total redundant resource value of the first-level account according to the n number of redundant resource values to obtain a first total redundant resource value;

wherein determining the allocated resource value allocated to the k number of second-level accounts in the m number of second-level accounts comprises:

determining l number of second-level accounts that need to allocate resources and l number of allocated resource values allocated to the l number of second-level accounts according to the first total redundant resource value and respective residual resource values of the m number of second-level accounts;

successively deducting the l number of allocated resource values from the first total redundant resource value to obtain l number of deduction results with respect to the l number of second-level accounts; and

determining the second-level account corresponding to a deduction result indicating a successful deduction among the l number of deduction results, thereby acquiring the k number of second-level accounts,

where l is a positive integer, l is greater than or equal to k, and l is less than or equal to m.

According to an embodiment of the present disclosure, determining the l number of second-level accounts that need to allocate resources comprises:

taking m as an initial value of p, performing the following operations cyclically until respective residual resource values of p number of second-level accounts are all less than an average value obtained by dividing a sum of resource values by p:

determining the first total redundant resource value and a sum of residual resource values of the p number of second-level accounts to obtain the sum of the resource values;

determining an average value obtained by dividing the sum of the resource values by p; and

determining second-level accounts whose residual resource value is less than the average value among the p number of second-level accounts, acquiring q number of second-level accounts, and making p=q;

wherein when the respective residual resource values of the p number of second-level accounts are all less than the average value, it is determined that the p number of second-level accounts are the l number of second-level accounts, and q is a positive integer less than p.

According to an embodiment of the present disclosure, determining the l number of allocated resource values allocated to the l number of second-level accounts comprises:

when the average value obtained by dividing the sum of the resource values by the l is an integer, determining the allocated resource values allocated to respective l number of second-level accounts to be differences between the average value and respective residual resource values of the l number of second-level accounts; or

when the average value obtained by dividing the sum of the resource values and the l is not an integer, determining the allocated resource values allocated to respective l number of second-level accounts to be differences between an integer value obtained by rounding down the average value and respective residual resource values of the l number of second-level accounts.

According to an embodiment of the present disclosure, the method further comprises: generating a first transaction detail data corresponding to the first total redundant resource value after instructing the first data center to update the total redundant resource value of the first-level account.

According to an embodiment of the present disclosure, successively deducting the l number of allocated resource values from the first total redundant resource value comprises:

successively performing the following operations until the l number of deduction results are obtained:

deducting an i-th allocated resource value from the first total redundant resource value to obtain a second total redundant resource value and an i-th deduction result; and

generating a second transaction detail data corresponding to the second total redundant resource value;

wherein the i-th deduction result is used to indicate whether the i-th allocated resource value is successfully deducted, and i is a positive integer belonging to [1, l].

According to an embodiment of the present disclosure, the method further comprises: after instructing the second data center to send respective redundant resource values of the n number of second-level accounts, perform the following operations: updating the residual resource values of the n number of second-level accounts and generating a third transaction detail data, wherein the third transaction detail data corresponds to updated residual resource values of the n number of second-level accounts; and/or, the method further comprises: generating a fourth transaction detail data after instructing the second data center to update the residual resource values of the k number of second-level accounts, wherein the fourth transaction detail data corresponds to the updated residual resource values of the k number of second-level accounts.

According to an embodiment of the present disclosure, determining the resource reference value with respect to the m number of second-level accounts comprises: determining the resource reference value of each second-level account in the m number of second-level accounts to be an average value of the m number of residual resource values.

Another aspect of the present disclosure provides a transaction data processing apparatus, comprising:

a first creation module for creating multiple data centers;

a second creation module for, with respect to at least two data centers in the multiple data centers, creating corresponding second-level accounts for a target payment institution respectively, wherein the second-level accounts support resource requirements of any third-level account corresponding to the target payment institution in the data centers;

a determination module for determining an available data center among the at least two data centers; and

a processing module for processing transaction data from the target payment institution by using a second-level account created for the target payment institution with respect to the available data center.

According to an embodiment of the present disclosure, the transaction data processing apparatus further comprises:

a third creation module for creating a corresponding first-level account for the target payment institution, wherein the first-level account is an upper-level account of all second-level accounts created with respect to the target payment institution;

a fourth creation module for creating an association relationship between the second-level accounts of the target payment institution and the first-level account of the target payment institution to obtain an account system of the target payment institution, wherein the association relationship includes that a resource amount in the first-level account and a resource amount in the second-level account are independent from each other and are mutually transferrable; and

a control module for controlling the transaction data to circulate in the account system during processing the transaction data of the target payment institution.

According to an embodiment of the present disclosure, the control module is further for: when a second-level account of the target payment institution corresponding to an available data center fails, using a second-level account of the target payment institution corresponding to any other available data center to process the transaction data of the target payment institution.

According to an embodiment of the present disclosure, the control module is further for: when a data center level resource amount of the target payment institution corresponding to an available data center is insufficient, using both a second-level account of the target payment institution corresponding to the available data center and a second-level account of the target payment institution corresponding to any other available data center to process the transaction data of the target payment institution.

According to an embodiment of the present disclosure, the transaction data processing apparatus further comprises: a fifth creation module for creating at least one third-level account for each second-level account of the target payment institution.

According to an embodiment of the present disclosure, the transaction data processing apparatus further comprises: a sixth creation module for creating transaction routes between different data centers to obtain a corresponding transaction system; and the processing module is further for, during processing the transaction data of the target payment institution, when an available data center fails or is busy, using any other available data center in the transaction system to process the transaction data of the target payment institution.

Another aspect of the present disclosure provides an electronic device, comprising:

one or more processors;

a memory for storing one or more programs,

wherein, when the one or more programs are executed by the one or more processors, the one or more processors are caused to implement any one of the transaction data processing methods as stated above.

Another aspect of the present disclosure provides a computer readable storage medium having executable instructions stored thereon, wherein when executed by a processor, the instructions causes the processor to implement any one of the transaction data processing methods as stated above.

Another aspect of the present disclosure provides a computer program comprising computer executable instructions for implementing any one of the transaction data processing methods as stated above when executed.

Another aspect of the present disclosure provides a transaction data processing system, comprising: a target payment institution; any one of the transaction data processing apparatus as stated above; and a transaction forwarding system comprising data centers created by the transaction data processing apparatus.

According to the embodiments of the present disclosure, by adopting the technical means of creating corresponding second-level accounts for the target payment institution in multiple data centers respectively and using the available data centers to process the transaction data of the target payment institution, the technical problems of high failure risk of single point and poor business continuity caused by the single account method or the primary-backup account method used by the account system in the prior art have been overcome at least partially, thereby achieving the technical effect of reducing the failure risk of single point and improving the business continuity.

### BRIEF DESCRIPTION OF DRAWINGS

Through the following description of the embodiments of the present disclosure with reference to the accompanying drawings, the above and other objectives, features, and advantages of the present disclosure will be more apparent. In the accompanying drawings:

FIG. 1 schematically shows the system architecture of a transaction data processing method in the prior art;

FIG. 2 schematically shows an exemplary system architecture to which the transaction data processing method of the present disclosure can be applied;

FIG. 3 schematically shows a flowchart of a transaction data processing method according to an embodiment of the present disclosure;

FIG. 4 schematically shows a flowchart of a transaction data processing method according to another embodiment of the present disclosure;

FIG. 5 schematically shows a flowchart of a transaction data processing method according to yet another embodiment of the present disclosure;

FIG. 6 is a schematic flowchart of still yet another transaction data processing method according to an embodiment of the present disclosure;

FIG. 7 is a schematic diagram of a provisions system according to an embodiment of the present disclosure;

FIG. 8A schematically shows a dispatching apparatus, a resource allocation method performed by the dispatching apparatus, and the system architecture of a distributed processing system according to an embodiment of the present disclosure;

FIG. 8B schematically shows an account hierarchical structure according to an embodiment of the present disclosure;

FIG. 9 schematically shows a flowchart of a resource allocation method performed by a dispatching apparatus according to a first embodiment of the present disclosure;

FIG. 10A schematically shows a flowchart of a resource allocation method performed by a dispatching apparatus according to a second embodiment of the present disclosure;

FIG. 10B schematically shows a flowchart of determining whether a residual resource value meets a preset condition according to an embodiment of the present disclosure;

FIG. 11 schematically shows a flowchart of instructing, by a dispatching apparatus, the first data center to perform an operation according to an embodiment of the present disclosure;

FIG. 12 schematically shows a flowchart of determining l number of second-level accounts that need to allocate resources according to an embodiment of the present disclosure;

FIG. 13 schematically shows a flowchart of successively deducting l number of allocated resource values from a first total redundant resource value according to an embodiment of the present disclosure;

FIG. 14 schematically shows a block diagram of the structure of a transaction data processing apparatus according to an embodiment of the present disclosure;

FIG. 15 schematically shows a block diagram of the structure of a transaction data processing apparatus according to an embodiment of the present disclosure;

FIG. 16 schematically shows a block diagram of the structure of a transaction data processing apparatus according to an embodiment of the present disclosure;

FIG. 17 schematically shows a block diagram of the structure of a transaction data processing system according to an embodiment of the present disclosure;

FIG. 18 schematically shows a block diagram of the structure of a transaction data processing apparatus according to an embodiment of the present disclosure; and

FIG. 19 schematically shows a block diagram of an electronic device suitable for implementing the transaction data processing method according to an embodiment of the present disclosure.

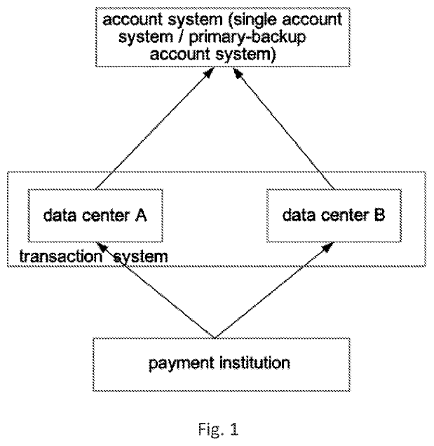

### DETAILED DESCRIPTION

Hereinafter, the embodiments of the present disclosure will be described below with reference to the drawings. However, it should be understood that the following description is only exemplary, and is not intended to limit the scope of the present disclosure. In the following detailed description, for ease of explanation, many specific details are set forth to provide a comprehensive understanding of the embodiments of the present disclosure. However, it is obvious that one or more embodiments can also be implemented without these specific details. In addition, in the following description, the description of well-known structures and technologies is omitted to avoid unnecessarily obscuring the concept of the present disclosure.

The terminology used herein is only for describing specific embodiments, and is not intended to limit the present disclosure. As used herein, the terms “comprises”, “comprising”, “includes” and “including” specify the presence of stated features, steps, operations, and/or components, but do not preclude the presence or addition of one or more other features, steps, operations, and/or components.

All terms (including technical and scientific terms) used herein have the meanings commonly understood by a person skilled in the art, unless otherwise defined. It should be noted that the terms used herein should be interpreted as having meanings consistent with the context of this specification, and should not be interpreted in an idealized or overly rigid manner.

In the case of using an expression like “at least one of A, B and C, etc.”, generally speaking, it should be interpreted according to the meaning of the expression commonly understood by a person skilled in the art (for example, “a system having at least one of A, B and C” shall include, but is not limited to, a system having A alone, a system having B alone, a system having C alone, a system having A and B, a system having A and C, a system having B and C, and/or a systems having A, B and C, etc.). In the case of using an expression such as “at least one of A, B and C, etc.”, generally speaking, it should be interpreted according to the meaning of the expression commonly understood by a person skilled in the art (for example, “a system having at least one of A, B and C” shall include, but is not limited to, a system having A alone, a system having B alone, a system having C alone, a system having A and B, a system having A and C, a system having B and C, and/or a systems having A, B and C, etc.).

The embodiments of the present disclosure provides a transaction data processing method, apparatus, device and system capable of improving business continuity. The method comprises: creating multiple data centers; with respect to at least two data centers in the multiple data centers, creating corresponding second-level accounts for a target payment institution respectively, wherein the second-level accounts support resource requirements of any third-level account corresponding to the target payment institution in the data centers; determining an available data center among the at least two data centers; and processing transaction data from the target payment institution by using a second-level account created for the target payment institution with respect to the available data center.

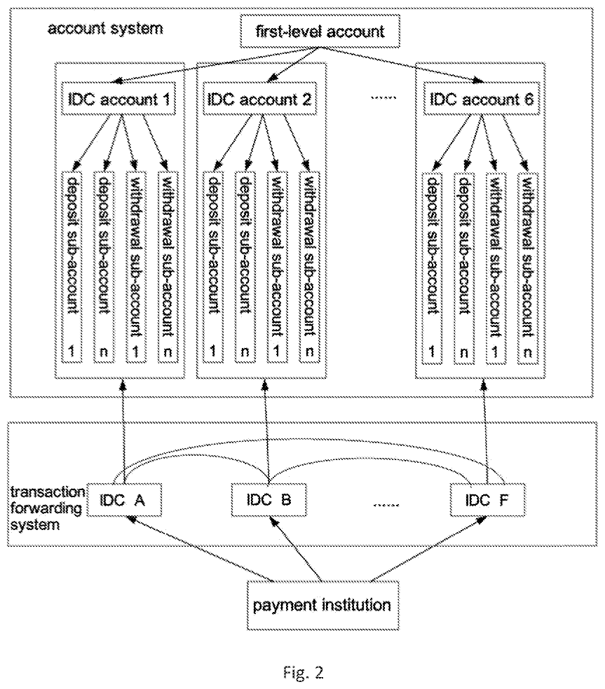

FIG. 2 schematically shows an exemplary system architecture to which the transaction data processing method of the present disclosure can be applied. It should be noted that FIG. 2 is only an example of the system architecture to which the embodiments of the present disclosure can be applied to help a person skilled in the art understand the technical content of the present disclosure, but it does not mean that the embodiments of the present disclosure cannot be used in other devices, systems, environments or scenarios.

As shown in FIG. 2, the system architecture (such as the system architecture for petty cash management) according to the present embodiment may comprise an account system, a transaction forwarding system and a payment institution.

The account system is provided with a first-level account, second-level accounts (such as IDC account 1˜IDC account 6) and third-level accounts (also known as deposit and withdrawal sub-accounts). Among them, the first-level account is the upper-level account of the second-level account, the third-level account is the lower-level account of the second-level account, and the lower-level accounts are related to each other through the corresponding upper-level account.

The transaction forwarding system may be provided with multiple data centers (such as IDC A˜IDC F) serving payment institutions. Each data center manages a second-level account. Corresponding transaction routes are provided between different data centers to form a network structure.

The account system may send the status information of each account to the transaction forwarding system, and the transaction forwarding system may send the status information of each data center to the payment institution. In this way, the payment institution can determine which data centers are currently available. At this time, if the payment institution has transaction data, such as fund inflow data, to be processed, it can send a service request to any currently available data center.

It should be noted that the data processing apparatus and the data processing method performed by it according to the embodiments of the present disclosure can be applied to this system architecture.

It should be understood that the quantity of data centers, second-level accounts and first-level accounts in FIG. 2 is only schematic. There may be any arbitrary number of data centers, second-level accounts and first-level accounts according to implementation needs.

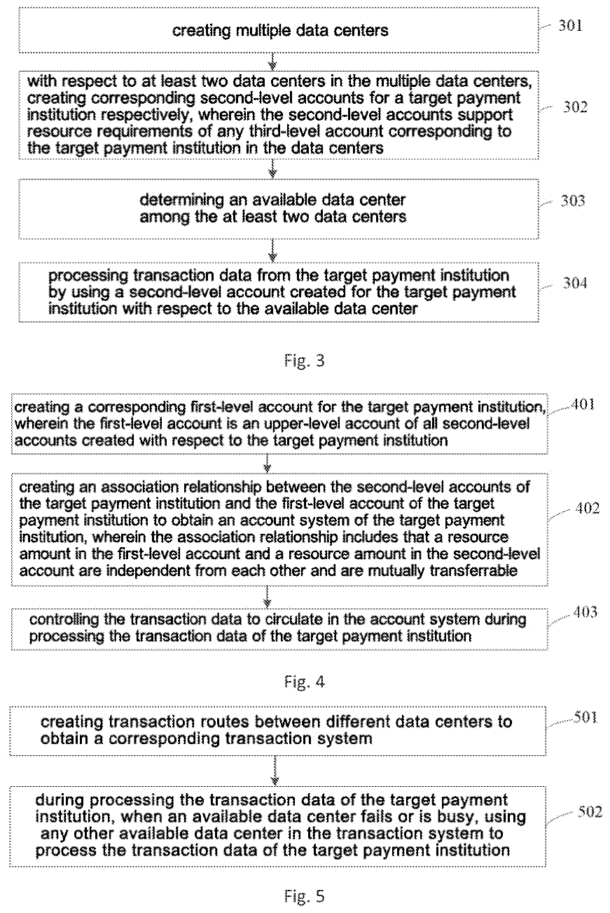

FIG. 3 schematically shows a flowchart of a transaction data processing method according to an embodiment of the present disclosure.

As shown in FIG. 3, the method comprises operations S301 to S304:

operation S301: creating multiple data centers;

operation S302: with respect to at least two data centers in the multiple data centers, creating corresponding second-level accounts for a target payment institution respectively, wherein the second-level accounts support resource requirements of any third-level account corresponding to the target payment institution in the data centers;

operation S303: determining an available data center among the at least two data centers; and

operation S304: processing transaction data from the target payment institution by using a second-level account created for the target payment institution with respect to the available data center.

It should be noted that in the embodiment of the present disclosure, a computer room may be a data center; a payment institution, an enterprise supporting payment business or an personal user may be a target payment institution.

Specifically, as shown in FIG. 2, six data centers, i.e., IDC A˜IDC F, serving the payment institutions may be created in advance. Take a payment institution as an example, a second-level account may be created for the payment institution in these six data centers respectively. That is, six second-level accounts, i.e., IDC account 1˜IDC account, may be created. When in use, the transaction system may collect the status information of these accounts and the status information of the corresponding data centers, and inform the payment institution which data centers are currently available. Then, if the payment institution has transaction data to process, it may randomly send a request to any of the available data centers.

Through the embodiment of the present disclosure, with respect to any target payment institution, an account is created for it in multiple data centers respectively, so that the account system is no longer a single account system or a primary-backup account system. Therefore, the single point of failure risk can be reduced and the business continuity can be improved.

The method shown in FIG. 3 will be further described below with reference to FIGS. 4 and 5 in conjunction with specific embodiments.

FIG. 4 schematically shows a flowchart of a transaction data processing method according to another embodiment of the present disclosure.

As an alternative embodiment, in addition to the operations shown in FIG. 3, the method may further comprise operations S401 to S403 as shown in FIG. 4, specifically,

operation S401: creating a corresponding first-level account for the target payment institution, wherein the first-level account is an upper-level account of all second-level accounts created with respect to the target payment institution;

operation S402: creating an association relationship between the second-level accounts of the target payment institution and the first-level account of the target payment institution to obtain an account system of the target payment institution, wherein the association relationship includes that a resource amount in the first-level account and a resource amount in the second-level account are independent from each other and are mutually transferrable; and

operation S403: controlling the transaction data to circulate in the account system during processing the transaction data of the target payment institution.

In order to reduce the risk of single point of failure and improve business continuity, the embodiment of the present disclosure has made improvement, and the single account system or primary-backup account has replaced by the account system including multiple discrete accounts. Thus, for a target payment institution, there can be multiple options to process the corresponding transaction data.

For example, in the system architecture shown in FIG. 2, if the status of IDC A˜IDC F are all available, the payment institution may randomly request any IDC to process its transaction data.

However, after creating multiple second-level accounts, the funds of the payment institution will generally be distributed in these accounts. Therefore, the funds in the second-level accounts corresponding to the randomly selected available data center may not be able to support the current transaction needs. For example, the payment institution currently needs to pay a fund of ¥1,000,000, but the IDC account 2 corresponding to the IDC B that it randomly requests is only ¥300,000.

In order to further improve business continuity, the embodiment of the present disclosure further improves the account system on the basis of the above embodiment. Specifically, in addition to creating the second-level account of the target payment institution, the corresponding first-level account and the association relationship between the second-levels of accounts are also created. In this way, when the randomly requested second-level account cannot support the current transaction needs, the funds may be circulated through other accounts of the target payment institution, so as to realize the circulation of funds among the whole account system, and thus realize the high availability withdrawals and deposits in the scenario of multiple computer rooms, i.e. multiple data centers. For example, the payment institution currently needs to pay a fund of ¥1,000,000, but the IDC account 2 corresponding to the IDC B it randomly requests is only ¥300,000, while the IDC account 3 and IDC account 6 corresponding to available IDC C and IDC F have ¥500,000 and ¥400,000 respectively. At this time, the transaction can be completed by fund circulation based on the solution provided in the embodiment of the present disclosure.

As an alternative embodiment, the above operation of controlling the transaction data to circulate in the account system may comprise: when a second-level account of the target payment institution corresponding to an available data center fails, using a second-level account of the target payment institution corresponding to any other available data center to process the transaction data of the target payment institution.

As an alternative embodiment, the above operation of controlling the transaction data to circulate in the account system may comprise: when a data center level resource amount of the target payment institution corresponding to an available data center is insufficient, using both a second-level account of the target payment institution corresponding to the available data center and a second-level account of the target payment institution corresponding to any other available data center to process the transaction data of the target payment institution.

In the embodiment of the present disclosure, the transaction data will generally be controlled to circulate in the account system of a target payment institution under the following cases: case 1, the data center level resource amount corresponding to the randomly requested available data center is insufficient to support the current transaction needs, which has been described in the previous embodiment and will not be repeated here; case 2, the randomly requested available data center fails.

With respect to case 2, a transaction route may be created among the data. Thus, once the requested data center fails, other available data centers may be notified to process the transaction data based on the transaction route. For example, in the system architecture shown in FIG. 2, if the payment institution randomly requests the IDC B to process the transaction data, but the IDC account 2 corresponding to the IDC B temporarily fails, and there is a transaction route between the IDC B and the IDC A, and between the IDC B and IDC F, so in this situation, the IDC A and/or the IDC F may be notified to process the transaction.

Through the embodiment of the present disclosure, it can be ensured that when the data center level resource amount is insufficient or when one or more originally available second-level accounts temporarily fail, funds can be transferred across machine rooms, so as not to affect the deposit and withdrawal business of the target payment institution.

As an alternative embodiment, the method may further comprise: creating at least one third-level account (also called deposit sub-account and withdrawal sub-account, as shown in FIG. 2) for each second-level account of the target payment institution.

That is, based on any of the foregoing embodiments, with respect to each target payment institution, on the basis of creating a second-level account for it, a third-level account of each second-level account may be further created, and the third-level account may be one or more. Thus, a data center may simultaneously use multiple third-level accounts to process deposit data and withdrawal data respectively. Furthermore, multiple third-level accounts may be used simultaneously to realize high availability withdrawals and/or high availability deposits.

It should be understood that in the embodiment of the present disclosure, the third-level account created under each second-level account belongs to the lower-level account of the second-level account.

FIG. 5 schematically shows a flowchart of a transaction data processing method according to yet any other embodiment of the present disclosure.

As an alternative embodiment, in addition to the operations shown in FIG. 3, the method may further comprise operations S501 and S502 shown in FIG. 5, specifically,

operation S501, creating transaction routes between different data centers to obtain a corresponding transaction system; and

operation S502, during processing the transaction data of the target payment institution, when an available data center fails or is busy, using any other available data center in the transaction system to process the transaction data of the target payment institution.

The available data centers may temporarily fail or are currently busy. In this situation, if the data centers are isolated from each other and there is no transaction route, the payment institution needs to repeatedly initiate requests to find a data center that can process its current transaction data, resulting in cumbersome data processing process.

In order to further overcome the above defect, the embodiment of the present disclosure makes further improvement on the basis of the previous embodiments, and creates a transaction route among the data centers. As shown in FIG. 2, transaction routes between IDC A and IDC B, IDC A and IDC F, IDC B and IDC F, . . . are created. Thus, if the requested IDC A temporarily fails or is currently busy, it can notify IDC B and/or IDC F, . . . , to respond to the request of the payment institution.

According to the embodiment of the present disclosure, by creating a transaction route, when an available data center temporarily fails or is busy, the transaction route created between different data centers of the transaction system may be used to notify other available data centers to respond to the current data processing request, so as to realize high availability withdrawals and/or deposits.

Based on the description of the above embodiment, it can also be understood that the provisions system can process the withdrawal and deposit business initiated by the payment institution. In practical applications, the provisions system adopts a discrete account system and constructs multi-level accounts. At present, the provisions system adopts the distribution mode of large and small accounts. External funds are remitted to the large account, and the large account regularly distributes funds to the small accounts. In such a solution, the funds are mainly retained in large accounts, and the fund distribution of accounts is different, resulting in uneven resource distribution.

Therefore, the following will describe in detail how to distribute the resources among multi-level accounts more evenly and avoid excessive concentration of resources in one account.

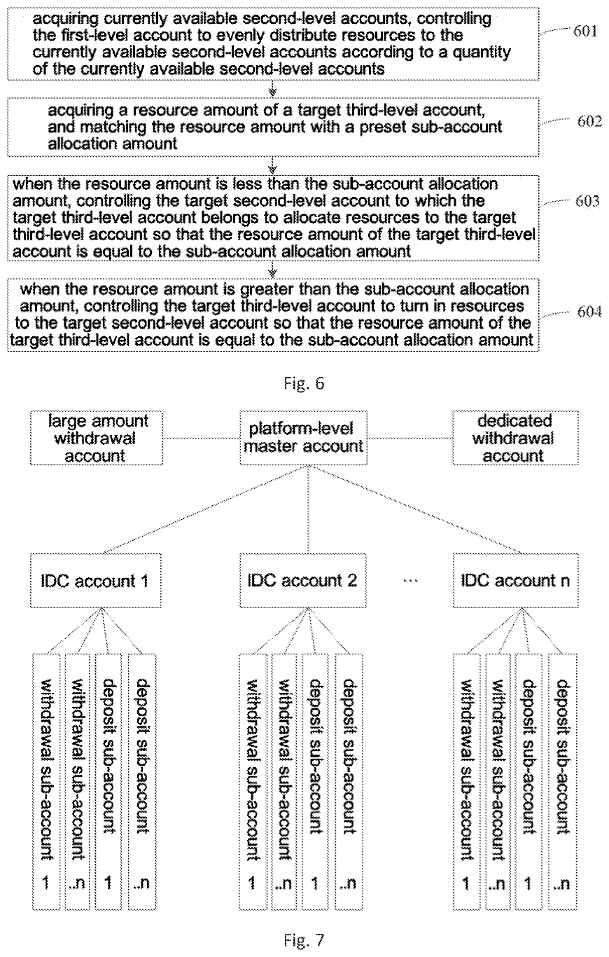

Specifically, FIG. 6 schematically shows a flowchart of a transaction data processing method according to still yet another embodiment of the present disclosure. As shown in FIG. 6, the method comprises:

Operation S601, acquiring currently available second-level accounts, controlling the first-level account to evenly distribute resources to the currently available second-level accounts according to a quantity of the currently available second-level accounts;

The resource allocation method of multi-level accounts according to the embodiment of the present disclosure can be applied to the provisions system. When applied to the provisions system, the allocated resources include funds. The provisions system is used to manage the pre-paid monetary funds actually received by the payment institution to handle the payment business entrusted by the customer. In this embodiment, a multi-level accounts system is constructed in the provisions system to support the processing of high concurrent real-time business.

In this embodiment, the multi-level accounts may include a first-level account, a second-level account and a third-level account. For example, the first-level account may include at least one second-level account, and each second-level account may include one or more third-level accounts.

In an embodiment of the present disclosure, when allocating resources based on multi-level accounts, the currently available second-level accounts may be acquired first, and the first-level account is controlled to evenly distribute resources to the currently available second-level accounts. For example, take the provisions system as an example, the first-level account is the primary account, and the second-level account is the IDC (Internet Data Center) account. After the external funds are remitted into the primary account, the IDC accounts in the available state may be acquired, and the primary account will evenly allocate the funds to the currently available IDC accounts according to the quantity of currently available IDC accounts.

Operation S602, acquiring a resource amount of a target third-level account, and matching the resource amount with a preset sub-account allocation amount;

In this embodiment, when allocating resources based on multi-level accounts, the resource amount of the target third-level account may be further acquired, and the resources are allocated to the target third-level account according to the resource amount of the target third-level account. Take the provisions system as an example, for example, the fund balance in each available third-level account may be acquired at a preset time interval, and the preset time interval may be set according to actual needs. For another example, the fund balance in the third-level account may be acquired when the fund of the third-level account changes. The target third-level account may be any available third-level account.

Specifically, the sub-account allocation amount of the third-level account may be preset, then the balance of each target third-level account may be matched with the preset sub-account allocation amount, and the corresponding fund allocation operation is performed according to the matching result, thereby realizing the fund balancing among the third-level accounts. The sub-account allocation amount may be set as required. For example, if the total allocation amount of the third-level account in the provisions system is set to N and the quantity of third-level accounts currently available is acquired as P, the sub-account allocation amount is N/P. Therefore, by presetting the allocation amount, the needs of the payment institution with different concurrent distributing amounts may be satisfied by allocating in different proportions.

Operation S603, when the resource amount is less than the sub-account allocation amount, controlling the target second-level account to which the target third-level account belongs to allocate resources to the target third-level account so that the resource amount of the target third-level account is equal to the sub-account allocation amount;

In this embodiment, take the reserve payment system as an example, if after matching the balance of the target third-level account with the preset sub-account allocation amount, the balance is known to be less than the sub-account allocation amount, then according to the difference between the sub-account allocation amount and the balance, the corresponding amount of fund is transferred from the target second-level account to the target third-level account, so that the balance of the target third-level account is equal to the allocation amount of the sub-account, thereby realizing the fund balancing among the third-level accounts by allocating funds to each third-level account.

The target second-level account is the second-level account to which the target third-level account belongs.

In an embodiment of the present disclosure, it may also occur that the target second-level account fails to allocate resources to the target third-level account. For example, when the status of the target second-level account is unavailable due to failure, or when the funds in the target second-level account are insufficient, the target second-level account may fail to allocate funds to the target third-level account. Therefore, it may be further detected whether the fund allocation from the target second-level account to the target third-level account fails. If the fund allocation fails, other available second-level accounts are acquired, and further controlled to allocate funds to the target third-level account.

As an example, if it is detected that the fund allocation fails, other available second-level accounts, that is, available second-level accounts other than the target second-level account are acquired, and then any of the other available second-level accounts is controlled to allocate funds to the target third-level account. As another example, if it is detected that the fund allocation fails, other available second-level accounts are acquired, and then the second-level account having the most funds among the other available second-level accounts is controlled to allocate funds to the target third-level account.

Operation S604, when the resource amount is greater than the sub-account allocation amount, controlling the target third-level account to turn in resources to the target second-level account so that the resource amount of the target third-level account is equal to the sub-account allocation amount.

In this embodiment, if after matching the balance of the target third-level account with the preset sub-account allocation amount, the balance is known to be greater than the sub-account allocation amount, then according to the difference between the sub-account allocation amount and the balance, the corresponding amount of fund is transferred from the target third-level account and turned in to the target second-level account, so that the balance of the target third-level account is equal to the allocation amount of the sub-account, thereby realizing the fund balancing among the third-level accounts by turning in the funds by the third-level accounts to the second-level account that they belong to.

In an embodiment of the present disclosure, it may also occur that the target third-level account fails to turn in resources to the target second-level account. For example, when the status of the target second-level account in the provisions system is unavailable due to failure, the target third-level account fails to turn in funds to the target second-level account. Therefore, it may be further detected whether the target third-level account fails to turn in funds to the target second-level account. If it is detected that it fails to turn in the funds, other available second-level accounts are acquired, and then the target third-level account is controlled to turn in funds to other available second-level accounts. Therefore, when the second-level account fails, the funds can be turned in, and thus the disaster tolerance of the system may be improved.

As an example, if it is detected that it fails to turn in the funds, other available second-level accounts are acquired, and then the target third-level account is controlled to turn in funds to any of the other available second-level accounts. As another example, if it is detected that it fails to allocate the funds, other available second-level accounts are acquired, and then the target third-level account is controlled to turn in funds to the second-level account having the least funds among the other available second-level accounts.

In an embodiment of the present disclosure, when the resource amount of the target third-level account is equal to the allocation amount of the sub-account, the resource allocation may not be performed.

Based on the above embodiment, further, it may occur that the status of the account may be unavailable when the provisions system is used. When the account is unavailable, it is necessary to perform fund aggregation on the funds in the account.

In an embodiment of the present disclosure, the status of each second-level account in the multi-level accounts may be also acquired. If it is known that the status of the current second-level account is unavailable, the resources of the current second-level account will be turned in to the first-level account. Further, if the status of the first-level account is unavailable, this resource turning in operation stops. Alternatively, the status of the second-level account may be acquired at a preset time interval, and the preset time interval may be set according to actual needs.

In an embodiment of the present disclosure, the status of each third-level account in the multi-level accounts may also be acquired. If it is known that the status of the current third-level account is unavailable, the resources of the current third-level account will be turned in to the second-level account to which the current third-level account belongs. Further, if the second-level account to which the current third-level account belongs is unavailable, the status of other second-level accounts is acquired, and the resources of the current third-level account are turned in to any other available second-level account. Further, if the status of the second-level accounts are all unavailable, this resource turning in operation stops.

The following describes the provisions system in conjunction with an actual application scenario.

Referring to FIG. 7, the provisions system shown is a three level account system, in which the first-level account includes a platform-level master account, a dedicated withdrawal account and a large amount withdrawal account; the second-level account includes IDC accounts; and the third-level account includes withdrawal sub-accounts and deposit sub-accounts. The dedicated withdrawal account is used to process dedicated withdrawal business, and the large amount withdrawal account is used to process large amount withdrawal business. The deposit sub-accounts are used to process deposit typed transactions.

For example, when the platform-level master account allocates funds to IDC accounts, the platform-level master account distributes funds evenly to all available IDC accounts according to the quantity of currently available IDC accounts. When allocating funds to the third-level withdrawal sub-accounts, the amount allocation value of the third-level accounts is N, and the quantity of currently available third-level withdrawal sub-accounts is P, if the amount of the current withdrawal sub-account is less than N/P, the IDC account of the center will make up the funds. If the allocation is unsuccessful, such as the IDC account of the center is unavailable or the amount is insufficient, any available IDC account will be selected to transfer funds. If it still fails, the fund transfer of the withdrawal sub-account will stop. If the current sub-account amount is greater than N/P, the withdrawal sub-account will turn in the excess funds to the IDC account of the center. If the IDC account is unavailable, it will be turned in to any other available IDC account. If there is no available IDC account, the fund transfer of the withdrawal sub-account will stop.

Further, during fund aggregation, if the IDC account is unavailable, the amount in this account will be turned in to the platform-level master account. If the platform-level master account is unavailable, this task will stop. If the withdrawal sub-account is unavailable, the amount in this account will be turned in to the IDC account of the center. If the IDC account of the center is unavailable, it shall be turned in to any other available IDC account. If there is no available IDC account, this task will stop.

In the transaction data processing method of the embodiment of the present disclosure, the currently available second-level accounts are acquired, and the first-level account is controlled to evenly distribute resources to the currently available second-level accounts according to the quantity of currently available second-level accounts. Then, the resource amount of the target third-level account is acquired and matched with the preset sub-account allocation amount. When the resource amount is less than the sub-account allocation amount, the target second-level account to which the target third-level account belongs is controlled to allocate resources to the target third-level account. When the resource amount is greater than the sub-account allocation amount, the target third-level account is controlled to turn in resources to the target second-level account so that the target third-level account resource amount is equal to the sub-account allocation amount. Thus, the resources are allocated or turned in according to the allocation amount, so that the resources are more evenly distributed among multi-level accounts. Compared with the allocation method of large and small accounts, the funds can be fully utilized and prevented from being mainly concentrated in the primary account, the impact of primary account failure is reduced, and the fault tolerance is improved. Moreover, through the multiple resource allocation logic among multi-level accounts, the disaster tolerance and fault tolerance in case of account failure are improved.

Based on the description of the above embodiment, it can also be understood that when the transferable resources of the accounts in the distributed system are dispatched and evenly distributed, the data centers in which the accounts are stored are often connected with each other, and each data center reads the residual resources of each account stored in other data centers except itself to transfer resources among the accounts. However, this method requires the data centers to be connected to each other (for the distributed system composed of N data centers, the quantity of connections required is at least N/2), so it will make the resource transfer highly complicated and the even distribution of resources will often fail.

In view of the above problem, the transaction data processing method of the present disclosure can realize the even distribution of resources among multiple second-level accounts by the addition of the first-level account and by the interaction between the dispatching apparatus and the first data center and the second data center, without the interconnection between the second data centers in which the multiple second-level accounts are stored. That is, each second data center only needs to pool its own resources to complete the resource balancing across machine rooms and across data centers, thereby achieve the technical effect of reducing the difficulty of resource transfer. It will be described in detail below in conjunction with the attached drawings.

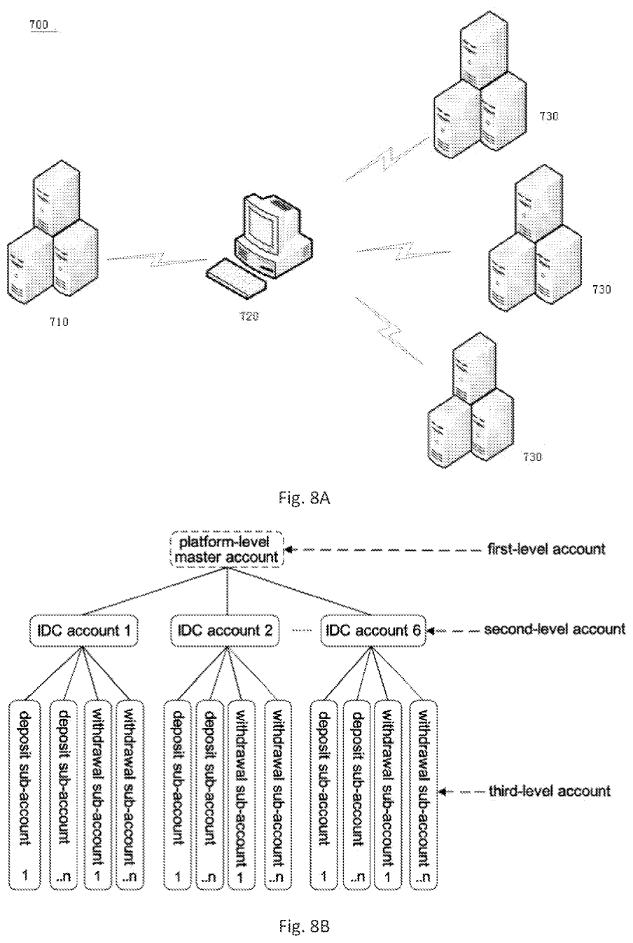

Specifically, FIG. 8A schematically shows a system architecture 700 of a transaction data processing method according to an embodiment of the present disclosure. FIG. 8B schematically shows an account hierarchical structure according to an embodiment of the present disclosure. It should be noted that FIG. 8A only shows an example of the system architecture to which the embodiment of the present disclosure can be applied so as to help a person skilled in the art understand the technical content of the present disclosure, but it does not mean that the embodiment of the present disclosure cannot be used in other devices, systems, environments or scenarios.

As shown in FIG. 8A, the system architecture 700 of the embodiment of the present disclosure comprises a first data center 710, a dispatching apparatus 720 and multiple second data centers 730. The dispatching apparatus 720 interacts with the first data center 710 and multiple second data centers 730 through a network. The network may include various connection types, such as wired, wireless communication links, etc.

The first data center 710 may be a computer cluster (as a master) of a primary process. It is configured to provide a platform-level first-level account to store the redundant resources turned in by multiple second-level accounts, and determine the allocated resources allocated to each second-level account provided by the same third party institution according to the redundant resources and the quantity of second-level accounts provided by the same third party institution. The second-level account may be provided for multiple second data centers 730. According to an embodiment of the present disclosure, the first-level account corresponds to multiple second-level accounts provided by the same third-party institution. When multiple third-party institutions create second-level accounts through the second data center, there are also multiple first-level accounts provided in the first data center, so that the first-level accounts correspond to the third-party institutions that create the second-level accounts one by one, so as to realize the even allocation of resources among multiple second-level accounts provided by the third-party institutions.

Each second data center of the multiple second data centers 730 may be a computer cluster of a sub process (as a worker), and correspondingly each second data center may be provided with one or more IDC (Internet Data Center) accounts, which are the above second-level accounts. According to an embodiment of the present disclosure, each second data center may be connected with a third-party institution and provide one or more IDC accounts for the third-party institution to process the real-time deposit and withdrawal business of the third-party institution. For example, the same third-party institution may be simultaneously connected with multiple second data centers 130 to use multiple IDC accounts. In order to improve business continuity as much as possible, it is necessary to ensure the even allocation to multiple IDC account resources provided by the third-party institutions.

In an embodiment, as shown in FIG. 8B, for example, multiple second data centers 730 may provide six IDC accounts, i.e., a first IDC account, a second IDC account, . . . and a sixth IDC account, to the third-party institution. The six IDC accounts correspond to the same platform-level master account (i.e. the first-level account provided in the first data center). Among the six IDC accounts, each IDC account may include, for example, multiple third-level accounts, and the multiple third-level accounts may include multiple (e.g., n number of) deposit sub-accounts and multiple (e.g., n number of) withdrawal accounts. For example, the residual resource value of each IDC account may be the total deposit amount of multiple deposit sub-accounts included in the IDC account minus the total withdrawal amount of multiple withdrawal accounts included in the IDC account. The number n is a natural number greater than 1. It can be understood that the account hierarchy in FIG. 8B is only used as an example to facilitate the understanding of the present disclosure. The application does not limit the quantity of IDC accounts corresponding to each platform-level master account and the quantity of third-level accounts included in each IDC account. For any legitimate third-party institution, the system architecture in FIG. 8A may provide an account hierarchy similar to that shown in FIG. 8B.

The dispatching apparatus 720 may be any electronic device with processing capability, including, but not limited to, mobile phone, tablet PC, laptop computer, desktop computer and server, etc. The dispatching apparatus 720 is specifically for monitoring the current available amount of multiple IDC accounts stored in multiple second data centers 730 (i.e., the residual resource value of multiple second-level accounts), so as to determine whether it is necessary to transfer the resources of multiple second-level accounts provided by the same third party according to the current available amount of each second-level account. The dispatching apparatus 720 is further for transferring resources through interaction with the second data center and the first data center stored in the multiple second-level accounts when it is necessary to transfer resources of multiple second-level accounts provided by the same third-party institution.

According to the embodiment of the present disclosure, when multiple second data centers 730 are connected to at least two third-party institutions, the first data center 720 may be a data center cluster to store at least two first-level accounts. In this situation, in order to improve the dispatching efficiency, the dispatching apparatus 720 may also be a computer cluster, for example, to transfer resources in parallel. According to the embodiment of the present disclosure, the dispatching apparatus 720 may also be integrated in any of the multiple second data centers 730, or the dispatching apparatus 720 may be integrated in the first data center 710, or the dispatching apparatus 720 may be integrated in other data centers independent of the first data center 710 and the second data center 730. Each first-level account corresponds to multiple second-level accounts created for a third-party institution.

It should be noted that the resource allocation method provided by the embodiment of the present disclosure may generally be performed by the dispatching apparatus 720. Accordingly, the dispatching apparatus provided by the embodiment of the present disclosure may be the dispatching apparatus 720. The distributed processing system provided by the embodiment of the present disclosure includes a data center cluster composed of a first data center 710, a dispatching apparatus 720, and a data center cluster composed of second data centers connected by the same third-party institution among the multiple second data centers 730.

It should be understood that the number and type of the first data center, the dispatching apparatus and the second data center in FIG. 8A are only schematic. According to the implementation needs, there may be any number and type of first data centers, dispatching apparatus and second data centers.

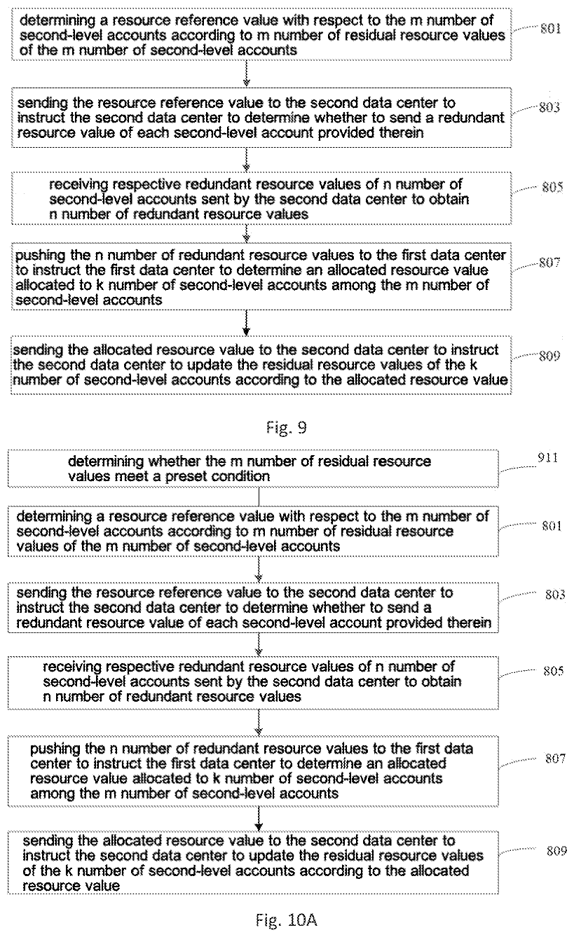

FIG. 9 schematically shows a flowchart of a transaction data processing method performed by the dispatching apparatus 720 according to a first embodiment of the present disclosure.

As shown in FIG. 9, the transaction data processing method comprises operations S801, S803, S805, S807 and S809 to ensure the even allocation of resources of the m number of second-level accounts provided by the same third-party institution. The dispatching apparatus 720 interacts with the first data center 710 providing the first-level account and the second data center 730 storing the m number of second-level accounts, and the first-level accounts correspond to the m number of second-level accounts.

In operation S801, the resource reference value with respect to the m number of second-level accounts is determined according to m number of residual resource values of the m number of second-level accounts.

The residual resource value may be, for example, the current available amount of each IDC account in the multiple IDC accounts provided in the second data center. Operation S801 is specifically for determining the reference available amount of the m number of IDC accounts according to the current available amount of the m number of IDC accounts. The number m is a positive integer.

The resource reference value is a reference value for the second data center to determine whether it is necessary to send the redundant resource values of the m number of second-level accounts to the dispatching apparatus in operation S803. In order to avoid the relevant interference of resources between IDC accounts, a processing logic of turning in based on the average value may be used to instruct the second data center to determine whether to send the redundant resource value of each IDC account in the m number of IDC accounts by taking the average value of the residual resource value of the m number of IDC accounts as a reference. Therefore, operation S801 may specifically determine that the resource reference value of each second-level account in the m number of second-level accounts is the average value of the m number of residual resource values. That is, it determines that the reference available amount is the average value of the current available amount of the m number of IDC accounts.

It can be understood that the above description that the resource reference value is the average value of the m number of residual resource values is only used as an example to facilitate the understanding of the present disclosure, and the specific value of the resource reference value is not limited in the present disclosure. For example, the resource reference value may also be greater than or less than the average value of the m number of residual resource values.

According to an embodiment of the present disclosure, each second-level accounts in the above m number of second-level accounts may include, for example, multiple third-level accounts, and the multiple third-level accounts may include multiple deposit sub-accounts and multiple withdrawal sub-accounts. For example, the residual resource value of each second-level account may be the total deposit amount of multiple deposit sub-accounts included in this second-level account minus the total withdrawal amount of multiple withdrawal sub-accounts included in this second-level account. It can be understood that the above description of the second-level account and the residual resource value of the second-level account is only an example to facilitate the understanding of the present disclosure, which is not limited in the present disclosure.

In operation S803, the resource reference value is sent to the second data center to instruct the second data center to determine whether to send a redundant resource value of each second-level account provided therein.

According to an embodiment of the present disclosure, the operation that the operation S203 instructs the second data center to perform may comprise, for example, first, determining whether to send the redundant resource value of each second-level accounts in the m number of second-level accounts according to the resource reference value; then, when it is determined to send the respective redundant resource values of n number of second-level accounts among the m number of second-level accounts, updating the respective residual resource values of then number of second-level accounts.

According to an embodiment of the present disclosure, the operation S803 may comprise, for example, sending the resource reference value determined in operation S801 to each second data center in one or more second data centers storing the m number of IDC accounts, and instructing each second data center to determine whether to send the redundant resource value of the IDC accounts stored therein. The redundant resource value may be the difference between the residual resource value and the reference resource value, specifically, it may be the excess amount obtained by subtracting the reference available amount from the current available amount of the IDC account.

When the residual resource value is greater than the reference resource value, it indicates that the current available amount of the IDC account stored in the second data center is large. When the residual resource value is less than the reference resource value, it indicates that the current available amount of the IDC account stored in the second data center is small, and it is necessary to transfer the resources of the IDC account with larger residual resource value to the IDC account with smaller residual resource value. Therefore, the operation of instructing the second data center to determine whether to send the redundant resource value of each second-level account in the m number of second-level accounts may comprise: instructing the second data center to determine whether the redundant resource value of each second-level account is greater than 0, and if the redundant resource value is greater than 0, sending the redundant resource value of the second-level account; If the redundant resource value is less than or equal to 0, it is not necessary to send the redundant resource value of the second-level account.

According to the embodiment of the present disclosure, if it is determined that the redundant resource value of n number of second-level accounts among the m number of second-level accounts is greater than 0, it is determined to send the respective redundant resource values of the n number of second-level accounts. After sending the respective redundant resource values of the n number of second-level accounts, in order to facilitate tracking and checking accounts, after instructing the second data center to send respective redundant resource values of the n number of second-level accounts, the second data center may also be instructed to update the residual resource values of the n number of second-level accounts according to the sent redundant resource values of n number of second-level accounts, and generating a third transaction detail data corresponding to the updated residual resource values of then number of second-level accounts.

Sending the redundant resource value may specifically be: deducting the excess amount on the basis of the current available amount of the IDC account provided in the second data center. Generating the third transaction detail data may comprise, for example, instructing the second data center in which the IDC account having been deducted the excess amount is stored to record the transfer details after the excess amount is deducted. The number n is a positive integer, and n is less than m.

In operation S805, the respective redundant resource values of n number of second-level accounts sent by the second data center are received to obtain n number of redundant resource values.

According to an embodiment of the present disclosure, receiving the redundant resource values in operation S805 may comprise, for example, determining the redundant resource values sent by the second data center which sends the redundant resource values of the IDC accounts stored therein. Specifically, it may comprise receiving the deduction amount fed back by the second data center in which the IDC account having been deducted the excess amount is stored.

In operation S807, the n number of redundant resource values are pushed to the first data center to instruct the first data center to determine allocated resource values allocated to k number of second-level accounts among the m number of second-level account.

In order to facilitate determining the resource value allocated to each second-level account, all redundant resource values received in operation S807 may be aggregated. Therefore, a first-level account corresponding to the m number of IDC accounts may be established, the first-level account is the account stored in the first data center 710 as the aggregation account of redundant resource values.

According to an embodiment of the present disclosure, the above operation S807 may be, for example, first, pushing the n number of redundant resource values to the first data center 710, instructing the first data center 710 to aggregate the n number of redundant resource values, and updating the total redundant resource value of the first-level account according to the aggregated results to obtain the first total redundant resource value. Then, the allocated resource value is determined according to the first total redundant resource value. In order to further facilitate the tracking and checking of accounts, the above resource allocation method may further comprise: instructing the first data center to generate the first transaction detail data corresponding to the first total redundant resource value after acquiring the first total redundant resource value. For example, in the process of aggregating the n number of redundant resource values, a transaction detail record corresponding to the first total redundant resource value may be generated in real time.

According to an embodiment of the present disclosure, in order to facilitate averaging the resources of the IDC accounts, the resource allocation process may be evenly allocating the updated first total redundant resource value to the m number of second-level accounts. Specifically, considering that the first total redundant resource value is not necessarily an integer multiple of m, in order to further ensure the averaging of the resources of the IDC accounts, determine the allocated resource value allocated to the m number of second-level accounts specifically comprises: when the value obtained by dividing the first total redundant resource value by m is an integer, determining that the allocated resource value allocated to each second-level accounts in the m number of second-level accounts is the value obtained by dividing the first total redundant resource value by m; when the value obtained by dividing the first total redundant resource value by m is not an integer, determining that the allocated resource value allocated to each second-level accounts in the m number of second-level accounts is the integer value rounded down from the value obtained by dividing the first total redundant resource value by m.

According to an embodiment of the present disclosure, the allocated resource value may specifically be the distribution amount allocated to the m number of second-level accounts determined according to the first total redundant resource value relative to the average value of the m number of second-level accounts.

According to an embodiment of the present disclosure, considering that the total redundant resource value of the first-level account stored by the first data center before aggregating the n number of redundant resource values may not be 0, the above aggregating the n number of redundant resource values may specifically be superimposing the n number of redundant resource values on the total redundant resource value of the first-level account to obtain the first total redundant resource value, and determining the allocated resource value allocated to the m number of second-level accounts according to the first total redundant resource value.

According to an embodiment of the present disclosure, after determining the allocated resource value allocated to the m number of second-level accounts, the allocated resource value may be sent to the second data center. In order to ensure the transaction balancing, before sending the allocated resource value allocated to an i-th second-level account among the m number of second-level accounts to the second data center, the amount allocated to the i-th second-level account needs to be deducted from the first-level account stored in the first data center, and only if the first-level account is deducted successfully, the allocated resource value allocated to the i-th second-level account is sent to the second data center. The value of i is a positive integer from 1 to m.

Therefore, before sending the allocated resource value to the second data center, the resource allocation method performed by the dispatching apparatus should also instruct the first data center to deduct the distributed amount. Then, the operations instructed to be performed by the first data center in operation S807 may comprise, for example, deducting the allocated resource value allocated to each second-level accounts in the m number of second-level accounts from the first total redundant resource value until m deduction results for the m number of second-level accounts are acquired, so as to based on the m number of deduction results, determine k number of second-level accounts among the m number of second-level accounts that may send allocated resource values. The deduction result of each second-level accounts in the k number of second-level accounts indicates that the distributed amount has been successfully deducted.

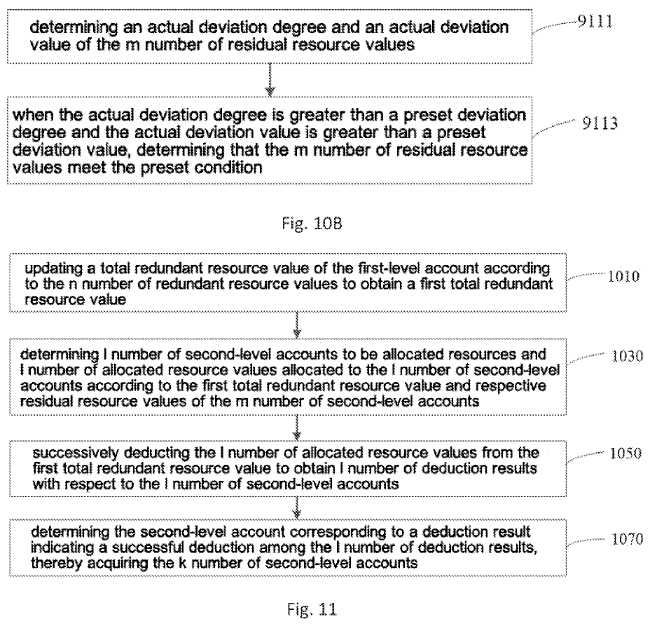

According to an embodiment of the present disclosure, the operations instructed to be performed by the first data center in operation S807 may comprise, for example, operations S1010, S1030, S1050 and S1070 described in FIG. 11, which are not described in detail here.

In operation S809, the allocated resource value is sent to the second data center to instruct the second data center to update the residual resource values of k number of second-level accounts according to the allocated resource value.

According to an embodiment of the present disclosure, the operation S809 may be, first, sending the allocated resource value to the second data center provided with the k number of second-level accounts, and then instructing the second data center provided with the k number of second-level accounts to increase the allocated resource value based on the current residual resource value of the k number of second-level accounts to obtain the updated residual resource value of the k number of second-level accounts. The allocated resource value may be the distribution amount, and updating the residual resource value may be increasing the distribution amount based on the current available amount of each IDC account.

According to an embodiment of the present disclosure, in order to facilitate checking the accounts, the resource allocation method may also instruct the second data center to generate a fourth transaction detail data corresponding to the updated residual resource values of the k number of second-level accounts after instructing the second data center to update the residual resource values of the k number of second-level accounts. Specifically, the second data center receiving the allocated distribution amount is instructed to record the receipt details after updating the current available amount of the IDC account stored therein.

In sum, the resource allocation method performed by the dispatching apparatus according to the embodiment of the present disclosure does not need to interconnect the multiple second data centers provided with the m number of IDC accounts when performing even resource allocation for the m number of IDC accounts connected to the third-party institution. The even allocation of resources may be realized only through the dispatching of the dispatching apparatus and the control of the dispatching apparatus over the first data center and the second data center. Therefore, the quantity of connections between the second data center in which the m number of IDC accounts are stored may be greatly reduced, so as to reduce the difficulty of cross data center resource allocation, and thus each second data center does not need to know the current residual resources of IDC accounts stored in other second data centers, but only by aggregating and transferring the residual resources of IDC accounts stored in itself, the cross regional and cross data center resource balancing can be realized.

In an embodiment, a dispatching apparatus, for example, may be provided in a first data center. At this time, pushing n number of redundant resource values to the first data center in operation S807 may comprise, for example, pushing the n number of redundant resource values from a first processing module in the first data center which is integrated with the dispatching apparatus to a second processing module provided with the first-level account.

In an embodiment, a dispatching apparatus, for example, may be provided in any one of the multiple second data centers. At this time, the operation of sending the resource reference value to the second data center in operation S803 may comprise, for example, sending the resource reference value to the processing module, provided with second-level accounts belonging to the m number of second-level accounts, in the second data center where the dispatching apparatus is located, and sending the resource reference value to other second data centers provided with second-level accounts belonging to the m number of second-level accounts. The operation of sending the allocated resource value to the second data center in operation S209 may comprise, for example, sending the allocated resource value to the processing module, provided with second-level accounts belonging to the m number of second-level accounts, in the second data center where the dispatching apparatus is located, and sending the allocated resource value to other second data centers with second-level accounts belonging to the m number of second-level accounts.

FIG. 10A schematically shows a flowchart of a transaction data processing method performed by a dispatching apparatus according to a second embodiment of the present disclosure, and FIG. 10B schematically shows a flowchart of determining whether the residual resource value meets a preset condition according to an embodiment of the present disclosure.

Considering that when the residual resource value difference between the m number of second-level accounts used by the third-party institution is small, the resource division of the m number of second-level accounts will lead to the consumption of unnecessary resources. Therefore, as shown in FIG. 10A, before operating S801, the resource allocation method of the embodiment of the present disclosure needs to determine whether to average the resources of the m number of second-level accounts by operating S911.

In operation S911, it is determined whether the m number of residual resource values meet a preset condition.

According to an embodiment of the present disclosure, the operation S911 may be, for example, determining whether the difference between the m number of residual resource values is greater than a preset difference. If it is greater than the preset difference, it indicates that the difference between the m number of residual resource values is large, and there is a need to divide the resources of the m number of second-level accounts. If it is less than the preset difference, it indicates that the difference between the m number of residual resource values is small, and there is no need to divide the resources of the m number of second-level accounts. Therefore, only when the m number of residual resource values meet the preset condition, operation S801 is performed to determine the resource reference values for the m number of second-level accounts.

According to an embodiment of the present disclosure, as shown in FIG. 11B, operation S911 may specifically comprise operations S9111 to S9113. In operation S9111, the actual deviation degree and actual deviation value of the m number of residual resource values are determined. In operation S9113, when the actual deviation degree is greater than the preset deviation degree and the actual deviation value is greater than the preset deviation value, it is determined that m number of residual resource values meet the preset condition.

Operation S9111 may specifically be, first, determining the maximum value M_max and the minimum value M_min among the m number of residual resource values, and then determining the actual deviation value d=M_max−M_min and actual deviation degree L=d/M_max=(M_max−M_min)/M_max. The values of the preset deviation degree and the preset deviation value in operation S9111 may be set according to the actual needs, and are not limited in the present disclosure.

In sum, the resource allocation method performed by the dispatching apparatus in the embodiment of the present disclosure may allocate resources only when the deviation of the m number of residual resource values of the m number of second-level accounts is large. Therefore, unnecessary resource allocation operations may be avoided to a certain extent, and resource consumption may be reduced.

According to an embodiment of the present disclosure, considering that after deducting the redundant resource value, the residual resource values of the n number of second-level accounts are the same as the resource reference values, if the total redundant resource value obtained after aggregation is divided equally among the m number of second-level accounts, there is still a resource imbalance among the m number of second-level accounts. Therefore, in order to balance the resources among the m number of second-level accounts as much as possible, operation S807 may, according to the residual resource values of the m number of second-level accounts and the first total redundant resource value of the first-level accounts, first exclude the second-level accounts whose residual resource values are still high after deducting the residual resource values, and only allocate resources to l number of second-level accounts with low residual resource values. The number l is a positive integer. Considering that the l number of second-level accounts are obtained by selecting from the m number of second-level accounts, l should be less than or equal to m.

FIG. 11 schematically shows a flowchart of instructing, by a dispatching apparatus, the first data center to perform an operation according to an embodiment of the present disclosure.

As shown in FIG. 11, the operations instructed to be performed by the first data center in operation S807 may comprise, for example, operations S1010 to S1070. The operation of determining the allocated resource value allocated to k number of second-level accounts among the m number of second-level accounts may comprise, for example, operations S1030, S1050 and S1070.

In operation S1010, the total redundant resource value of the first-level account is updated according to n number of redundant resource values to obtain the first total redundant resource value. The first total redundant resource value obtained in operation S1010 is the same as the above first total redundant resource value, which will not be repeatedly described here.

In operation S1030, l number of second-level accounts that need to allocate resources and l number of allocated resource values allocated to l number of second-level accounts are determined according to the first total redundant resource value and the respective residual resource values of the m number of second-level accounts.

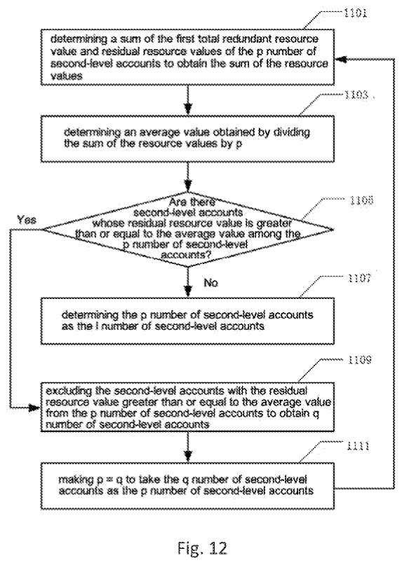

According to an embodiment of the present disclosure, the operation of determining l number of second-level accounts that need to allocate resources in operation S1030 may comprise, for example, cyclically excluding second-level accounts whose residual resource values are relatively high among the m number of second-level accounts until the residual resource value of each second-level account in the remaining second-level accounts are less than the average resource values of the remaining second-level accounts, to obtain l number of second-level accounts. Operation S1030 may, for example, determine the allocated resource value allocated to each second-level accounts in the l number of second-level accounts according to the average resource value of the l number of second-level accounts. The average resource value of the l number of second-level accounts is the average value obtained by dividing the sum of the first total residual resource value and the residual resource values of the l number of second-level accounts by the l number of second-level accounts. According to an embodiment of the present disclosure, the operation of determining 1 number of second-level accounts that need to allocate resources in operation S1030 may be realized, for example, by operations S1101, S1103, S1105, S1107, S1109 and S1111 described in FIG. 12, which will not be described in detail here.

According to an embodiment of the present disclosure, when the average resource value for the l number of second-level accounts is an integer, it may be determined that the allocated resource value allocated to each second-level accounts in the l number of second-level accounts is the difference between the average resource value and the residual resource value of each second-level account. When the average resource value of the l number of second-level accounts is not an integer, it may be determined that the allocated resource value allocated to each second-level accounts in the l number of second-level accounts is the difference between the integer value rounded down from the average resource value and the residual resource value of each second-level account.

In operation S1050, l number of allocated resource values are successively deducted from the first total redundant resource value to obtain l number of deduction results for l number of second-level accounts.

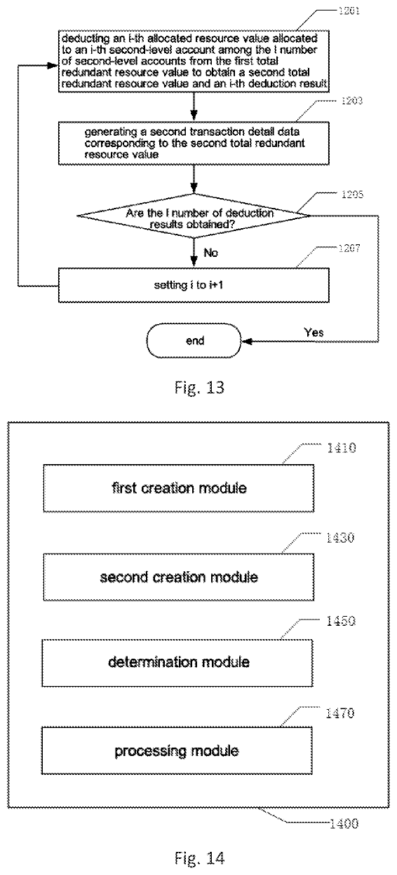

According to the embodiment of the present disclosure, the operation S1050 may, for example, obtain the l number of deduction results by successively performing operations S1201 and S1203 described in FIG. 13. Specifically, the operation S1050 may comprise operations S1201 and S1203 described in FIG. 13, which will not be described in detail here.

In operation S1070, the second-level accounts corresponding to the deduction result indicating the successful deduction among the l number of deduction results are determined to obtain k number of second-level accounts.

According to an embodiment of the present disclosure, after instructing the first data center to obtain the l number of deduction results, the k number of second-level accounts that need to allocate resources may be determined according to the l number of deduction results. The operation S1070 may specifically comprise, for example, determining the second-level account corresponding to the deduction value successfully deducted by the first-level account as one of the k number of second-level accounts. According to an embodiment of the present disclosure, in order to facilitate determining the corresponding relationship between the deduction results and the second-level accounts, the deduction result obtained by the first data center may not only indicate whether the i-th deduction value is successfully deducted, but also, for example, indicate the corresponding second-level account. Specifically, the deduction result carries an identifier identifying the corresponding second-level account, so that the dispatching apparatus may send the allocated resource value to the second data center provided with the corresponding second-level account according to the identifier. The number k is a positive integer. Considering that the k number of second-level accounts are obtained by selecting from the l number of second-level accounts, k should be less than or equal to 1.

FIG. 12 schematically shows a flowchart for determining the l number of second-level accounts that need to allocate resources according to an embodiment of the present disclosure.

According to an embodiment of the present disclosure, in order to facilitate the first data center to determine the l number of second-level accounts that need to allocate resources, as shown in FIG. 12, in operation S807, the operation of instructing the first data center to determine the l number of second-level accounts that need to allocate resources after pushing n number of redundant resource values to the first data center may, for example, comprise: taking m as an initial value of p, performing cyclically operations S1101, S1103, S1105, S1107, S1109 and S1111 until the respective residual resource values of the p number of second-level accounts are all less than an average value obtained by dividing a sum of resource values by p.

In operation S1101, the sum of the first total redundant resource value and the residual resource values of the p number of second-level accounts is determined to obtain the sum of the resource values. In operation S1103, an average value obtained by dividing the sum of resource values by p is determined. In operation S1105, it is determined whether there is a second-level account with a residual resource value greater than or equal to the average value among the p number of second-level accounts. The average value is similar to the above average resource value for the l number of second-level accounts, which will not be repeatedly described here.

When it is determined in operation S1105 that the residual resource values of the p number of second-level accounts are all less than the average value, it indicates that the p number of second-level accounts are all accounts that need to allocate resources, and thus operation S1107 is performed to determine that the p number of second-level accounts are the 1 number of second-level accounts.

When it is determined in operation S1105 that only q (q is a positive integer less than p) number of second-level accounts among the p number of second-level accounts have a residual resource value less than the average value, it indicates that there are second-level accounts with a residual resource value greater than or equal to the average value among the p number of second-level accounts. At this time, operations S1109 and S1111 are performed.

In operation S1109, the second-level accounts with the residual resource value greater than or equal to the average value are excluded from the p number of second-level accounts to obtain q number of second-level accounts. In operation S1111, make p=q to take the q number of second-level accounts as the p number of second-level accounts, and go back to perform cyclically operations S1101, S1103, S1105, S1107 and S1109.

According to an embodiment of the present disclosure, the above operation of determining the l number of second-level accounts that need to allocate resources may comprise the following steps. First, a first sum of the remaining amount of the first-level account and all second-level accounts is calculated. Then, the first sum is divided by the quantity of second-level accounts to obtain a first average value. Then, the remaining amount of each second-level account in the multiple second-level accounts is compared with the first average value. If the remaining amount is greater than or equal to the first average value, the second-level account is removed so that the second-level account will not participate in fund allocation. After removing all second-level accounts with residual amount greater than the first average value, a second sum of the residual amount of the first-level account and the residual amounts of the remaining second-level accounts after removal is calculated, and then is divided by the quantity of the remaining second-level accounts after removal to obtain an average value as a second average value. Then, the second-level accounts with the remaining amount greater than or equal to the second average value in the remaining second-level accounts are further removed, and so on, until the remaining amounts of all remaining second-level accounts are all less than the recalculated average value. The allocated resource value allocated to the final remaining second-level account may be, for example, the difference between the recalculated average value and the remaining amount of the final remaining second-level account. Specifically, when the average value is an integer, it is determined that the allocated resource value allocated to the l number of second-level accounts is the difference between the average value and the respective residual resource value of the l number of second-level accounts. When the average value is not an integer, it is determined that the allocated resource value allocated to the l number of second-level accounts is the difference between the integer value rounded down from the average value and the respective residual resource value of l number of second-level accounts.

For example, if there are six second-level accounts, the remaining amounts of the six second-level accounts is 1, 2, 3, 4, 5 and 15 respectively, and the remaining amount of the first-level account is 30, the first average value calculated will be (30+1+2+3+4+5+15)/6=10. Among them, the second-level account with the remaining amount of 15 is the second-level account to be removed. Then, the remaining amounts of the second-level accounts with the remaining amount of 1, 2, 3, 4 and 5 respectively and the remaining amount of the first-level account are calculated, and the second average value calculated is (30+1+2+3+4+5)/5=9. At this time, it may be determined that the second-level accounts with remaining amounts of 1, 2, 3, 4 and 5 are all accounts that need to participate in fund allocation. The allocated resource values allocated to the five second-level accounts with residual amounts of 1, 2, 3, 4 and 5 are 8, 7, 6, 5 and 4 respectively.

According to an embodiment of the present disclosure, after determining the allocated resource value allocated to the l number of second-level accounts, the allocated resource value may be sent to the second data center. In order to ensure the transaction balancing, before sending the allocated resource value allocated to an i-th second-level account to the second data center, the amount allocated to the i-th second-level account needs to be deducted from the first-level account stored in the first data center, and only if the first-level account is deducted successfully, the allocated resource value allocated to the i-th second-level account is sent to the second data center. The value of i is a positive integer from 1 to m.

FIG. 13 schematically shows a flowchart of successively deducting the l number of allocated resource values from the first total redundant resource value according to an embodiment of the present disclosure.

As shown in FIG. 13, before sending the allocated resource value to the second data center, the resource allocation method performed by the dispatching apparatus shall also instruct the first data center to deduct the distributed amount. In operation S807, in addition to the operations S1101, S1103, S1105, S1107, S1109 and S1111, the operations instructed to be performed by the first data center further comprise operations S1201, S1203, S1205 and S1207 until the l number of deduction results are obtained, so as to determine k number of second-level accounts among the l number of second-level accounts that may send the allocated resource value according to the l number of deduction results. Specifically, the operations instructed to be performed by the first data center may comprise, for example, operations S1201, S1203, S1205 and S1207 performed successively until the l number of deduction results are obtained.

In operation S1201, the i-th allocated resource value is deducted from the first total redundant resource value to obtain the second total redundant resource value and the i-th deduction result. The i-th allocated resource value is, for example, the allocated resource value allocated to the i-th second-level account among the l number of second-level accounts.

In operation S1203, a second transaction detail data corresponding to the second total redundant resource value is generated. The i-th deduction result is used to indicate whether the i-th allocated resource value is successfully deducted. The second transaction detail data is the transfer details after the i-th allocated resource value is deducted from the first-level account.

According to an embodiment of the present disclosure, in order to avoid confusion in deducting when there are multiple allocated resource values, the l number of allocated resource values may also be numbered to obtain allocated resource values numbered from 1 to l. The specific process of obtaining the l number of deduction results is as follows. Take 1 as the initial value of i, and the i-th allocated resource value numbered i is deducted by cyclically performing operations S1201, S1203, S1205 and S1207 until the l number of deduction results are obtained. The operation S1205 is used to determine whether the l number of deduction results are obtained. If the l number of deduction results are obtained, the deduction of the total redundant resource value is finished. If the l number of deduction results have not been obtained, operation S1207 is performed, i is set to i+1, and then go back to operation S1201.

According to an embodiment of the present disclosure, the above operation S1205 may also specifically be, determining whether i is less than 1, and if i is less than m, performing operation S1207; if i is not less than 1, finishing the deduction of the total redundant resource value.

FIG. 14 schematically shows a block diagram of the structure of a transaction data processing apparatus according to an embodiment of the present disclosure.

As shown in FIG. 14, the transaction data processing apparatus 1400 with respect to a payment institution includes a first creation module 1410, a second creation module 1420, a determination module 1430, and a processing module 1440.

The first creation module 1410 is for creating multiple data centers.

The second creation module 1420 is for, with respect to at least two data centers in the multiple data centers, creating corresponding second-level accounts for a target payment institution. The second-level accounts support the resource requirements of any third-level account corresponding to the target payment institution in the data centers.

The determination module 1430 is for determining an available data center among the at least two data centers.

The processing module 1440 is for processing transaction data from the target payment institution by using a second-level account created for the target payment institution with respect to the available data center.

Through the embodiment of the present disclosure, with respect to any target payment institution, an account is created for it in multiple data centers respectively, so that the account system is no longer a single account system or a primary-backup account system. Therefore, the single point of failure risk can be reduced and the business continuity can be improved.

As an alternative embodiment, the apparatus may further comprise: a third creation module for creating a corresponding first-level account for the target payment institution, wherein the first-level account is an upper-level account of all second-level accounts created with respect to the target payment institution; a fourth creation module for creating an association relationship between the second-level accounts of the target payment institution and the first-level account of the target payment institution to obtain an account system of the target payment institution, wherein the association relationship includes that a resource amount in the first-level account and a resource amount in the second-level account are independent from each other and are mutually transferrable; and a control module for controlling the transaction data to circulate in the account system during processing the transaction data of the target payment institution.

Through the embodiment of the present disclosure, the funds may be circulated through other accounts of the target payment institution, so as to realize the circulation of funds among the whole account system, and thus realize the high availability withdrawals and deposits in the scenario of multiple computer rooms, i.e. multiple data centers.

As an alternative embodiment, the control module may also be used for, when a second-level account of the target payment institution corresponding to an available data center fails, using a second-level account of the target payment institution corresponding to any other available data center to process the transaction data of the target payment institution.

As an alternative embodiment, the control module may further used for, when a data center level resource amount of the target payment institution corresponding to an available data center is insufficient, using both a second-level account of the target payment institution corresponding to the available data center and a second-level account of the target payment institution corresponding to any other available data center to process the transaction data of the target payment institution.

Through the embodiment of the present disclosure, it can be ensured that when the data center level resource amount is insufficient or when one or more originally available second-level accounts temporarily fail, funds can be transferred across machine rooms, so as not to affect the deposit and withdrawal business of the target payment institution.

As an alternative embodiment, the apparatus may further comprise: a fifth creation module for creating at least one third-level account for each second-level account of the target payment institution.

Through the embodiments of the present disclosure, a data center may simultaneously use third-level accounts to process fund inflow data and fund outflow data respectively. Further, multiple third-level accounts (fund inflow sub-account and fund outflow sub-account) may be used simultaneously to realize high availability withdrawals and/or high availability deposits.

As an alternative embodiment, the apparatus may further comprise: a sixth creation module for creating transaction routes between different data centers to obtain a corresponding transaction system; and the processing module is further for, during processing the transaction data of the target payment institution, when an available data center fails or is busy, using any other available data center in the transaction system to process the transaction data of the target payment institution.

According to the embodiment of the present disclosure, by creating a transaction route, when an available data center temporarily fails or is busy, the transaction route created between different data centers of the transaction system may be used to notify any other available data center to respond to the current data processing request, so as to realize high availability withdrawals and/or deposits.

Any number of modules according to the embodiments of the present disclosure or at least part of the functions thereof may be implemented in one module. Any one or more of the modules according to the embodiments of the present disclosure may be split into multiple modules for implementation. Any one or more of the modules according to the embodiments of the present disclosure may be at least partially implemented as hardware circuits, for example, field programmable gate array (FPGA), programmable logic array (PLA), system on chip, system on substrate, system on package, application-specific integrated circuit (ASIC), or implemented as hardware or firmware that integrate or package a circuit in any suitable way, or implemented in any one or a suitable combination of the following three ways: software, hardware, and firmware. Alternatively, one or more of the modules according to the embodiments of the present disclosure may be at least partially implemented as a computer program module, and when the computer program module is executed, the corresponding function may be performed.

For example, any number of the first creation module 1410, the second creation module 1420, the determination module 1430, and the processing module 1440 can be combined into one module/unit/sub-unit for implementation; alternatively, any one of the modules can be split into multiple modules/units/sub-units. Alternatively, at least part of the functions of one or more of these modules can be combined with at least part of the functions of other modules, and implemented in one module/unit/sub-unit. According to an embodiment of the present disclosure, at least one of the first creation module 1410, the second creation module 1420, the determination module 1430, and the processing module 1440 may be at least partially implemented as hardware circuits, for example, field programmable gate array (FPGA), programmable logic array (PLA), system on chip, system on substrate, system on package, application-specific integrated circuit (ASIC), or implemented as hardware or firmware that integrate or package a circuit in any suitable way, or implemented in any one or a suitable combination of the following three ways: software, hardware, and firmware. Alternatively, at least one of the first creation module 1410, the second creation module 1420, the determination module 1430, and the processing module 1440 may be at least partially implemented as a computer program module, and when the computer program module is executed, the corresponding function may be performed.

It should be noted that the embodiments of the apparatus part in the embodiments of the present disclosure are the same or similar to the embodiments of the method part in the embodiments of the present disclosure. For the description of the embodiments of the apparatus part, please refer to the description of the embodiments of the method part, which will not be repeated here.

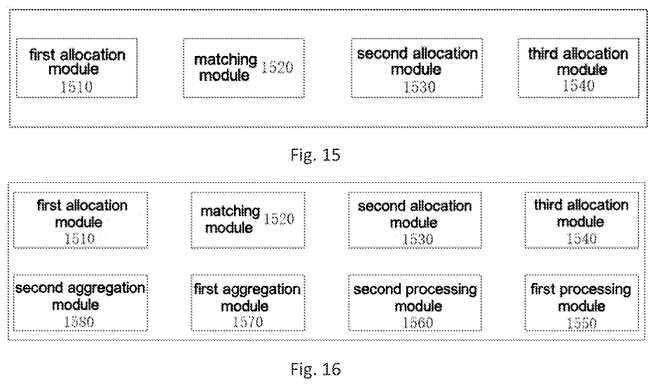

FIG. 15 schematically shows a block diagram of the structure of a transaction data processing apparatus according to an embodiment of the present disclosure. As shown in FIG. 15, the apparatus comprises a first allocation module 1510, a matching module 1520, a second allocation module 1530 and a third allocation module 1540.

The first allocation module 1510 is for acquiring currently available second-level accounts, controlling the first-level account to evenly distribute resources to the currently available second-level accounts according to a quantity of the currently available second-level accounts.

The matching module 1520 is for acquiring a resource amount of a target third-level account, and matching the resource amount with a preset sub-account allocation amount.

The second allocation module 1530 is for, when the resource amount is less than the sub-account allocation amount, controlling the target second-level account to which the target third-level account belongs to allocate resources to the target third-level account so that the resource amount of the target third-level account is equal to the sub-account allocation amount.

The third allocation module 1540 is for, when the resource amount is greater than the sub-account allocation amount, controlling the target third-level account to turn in resources to the target second-level account so that the resource amount of the target third-level account is equal to the sub-account allocation amount.

As a possible implementation method, the sub-account allocation amount=a total allocation amount/a quantity of currently available third-level accounts.

On the basis of FIG. 15, the apparatus shown in FIG. 16 further comprises a first processing module 1550, a second processing module 1560, a first aggregation module 1570 and a second aggregation module 1580.

The first processing module 1550 is for detecting whether the target second-level account fails to allocate resources to the target third-level accounts; if the resource allocation failure is detected, acquiring other available second-level accounts; and controlling the other available second-level accounts to allocate resources to the target third-level accounts.

The second processing module 1560 is for detecting whether the target third-level accounts fails to turn in resources to the target second-level account; if the resource turning in failure is detected, acquiring other available second-level accounts; and controlling the target third-level account to turn in resources to the other available second-level accounts.

The first aggregation module 1570 is for acquiring the status of each second-level account in the multi-level accounts; and if it is known that the status of the current second-level account is unavailable, turning in the resources of the current second-level account to the first-level account.

The second aggregation module 1580 is for acquiring the status of each third-level account in the multi-level accounts; if it is known that the status of the current third-level account is unavailable, turning in the resources of the current third-level account to the second-level account to which the current third-level account belongs; if the second-level account to which the current third-level account belongs is unavailable, turning in the resources of the current third-level account to any other available second-level account.

It should be noted that the explanation of the resource allocation method of the multi-level accounts in the above embodiments is also applicable to the resource allocation apparatus of the multi-level accounts in this embodiment, which will not be repeated here.

In the transaction data processing apparatus of the embodiment of the present disclosure, the currently available second-level accounts are acquired, and the first-level account is controlled to evenly distribute resources to the currently available second-level accounts according to the quantity of currently available second-level accounts. Then, the resource amount of the target third-level account is acquired and matched with the preset sub-account allocation amount. When the resource amount is less than the sub-account allocation amount, the target second-level account to which the target third-level account belongs is controlled to allocate resources to the target third-level account. When the resource amount is greater than the sub-account allocation amount, the target third-level account is controlled to turn in resources to the target second-level account so that the target third-level account resource amount is equal to the sub-account allocation amount. Thus, the resources are allocated or turned in according to the allocation amount, so that the resources are more evenly distributed among multi-level accounts. Compared with the allocation method of large and small accounts, the funds can be fully utilized and prevented from being mainly concentrated in the primary account, the impact of primary account failure is reduced, and the fault tolerance is improved. Moreover, through the multiple resource allocation logic among multi-level accounts, the disaster tolerance and fault tolerance in case of account failure are improved.

FIG. 17 schematically shows a block diagram of the structure of a transaction data processing apparatus according to an embodiment of the present disclosure.

As shown in FIG. 17, the transaction data processing apparatus 1700 of the embodiment of the present disclosure comprises: a resource reference value determination module 1701, a first instructing module 1703, an redundant resource value receiving module 1705 and a second instructing module 1707. The transaction data processing apparatus 1700 may be, for example, the dispatching apparatus 720 in FIG. 8A. The transaction data processing apparatus 1700 may interact with the first data center 710 provided with first-level accounts and the second data center 730 provided with m number of second-level accounts. The m number of second-level accounts provided by the second data center 730 are the m number of IDC accounts provided for the same third-party institution. The first-level account corresponds to the m number of second-level accounts.

The resource reference value determination module 1701 is for determining a resource reference value with respect to the m number of second-level accounts according to m number of residual resource values of them number of second-level accounts (operation S801), where m is a positive integer.

The first instructing module 1703 is for sending the resource reference value to the second data center to instruct the second data center to determine whether to send a redundant resource value of each second-level account provided therein (operation S803).

The redundant resource value receiving module 1705 is for receiving respective redundant resource values of n number of second-level accounts sent by the second data center to obtain n number of redundant resource values (operation S805), where n is a positive integer and n is less than m.

The second instructing module 1707 is for pushing the n number of redundant resource values to the first data center to instruct the first data center to determine an allocated resource value allocated to k number of second-level accounts among the m number of second-level accounts (operation S807), where k is a positive integer and k is less than or equal to m.

The first instructing module 1703 is further for sending the allocated resource value to the second data center to instruct the second data center to update the residual resource values of the k number of second-level accounts according to the allocated resource value (operation S809), where k is a positive integer.

According to an embodiment of the present disclosure, the dispatching apparatus 1700 further comprises a preprocessing module 1709 for determining whether the m number of residual resource values meet a preset condition (operation S911). The resource reference value determination module 1701 is specifically for determining the resource reference value for the m number of second-level accounts when the m number of residual resource values meet the preset condition.

According to an embodiment of the present disclosure, the preprocessing module 1709 comprises a processing sub-module 1719 and a determination sub-module 1739. The processing sub-module 1719 is for determining the actual deviation degree and actual deviation value of the m number of residual resource values (operation S9111). The determination sub-module 1739 is for determining that the m number of residual resource values meet the preset condition when the actual deviation degree is greater than the preset deviation degree and the actual deviation value is greater than the preset deviation value (operation S9113).

According to an embodiment of the present disclosure, the first instructing module 1703 is further for instructing the second data center to do as follows: update the respective residual resource values of n number of second-level accounts when it is determined to send the respective redundant resource values of n number of second-level accounts. The second instructing module 1707 is further for instructing the first data center to do as follows: update the total redundant resource value of the first-level account according to the n number of redundant resource values to obtain the first total redundant resource value (operation S1010). For example, the second instructing module 1707 may be, for example, for instructing the first data center to determine the allocated resource values allocated to the k number of second-level accounts among the m number of second-level accounts by the following operations: determining l number of second-level accounts that need to allocate resources and 1 number of allocated resource values allocated to the l number of second-level accounts according to the first total redundant resource value and respective residual resource values of the m number of second-level accounts (operation S1030); successively deducting the 1 number of allocated resource values from the first total redundant resource value to obtain 1 number of deduction results with respect to the l number of second-level accounts (operation S1050); determining the second-level account corresponding to a deduction result indicating a successful deduction among the l number of deduction results, thereby acquiring the k number of second-level accounts (operation S1070), where 1 is a positive integer, 1 is greater than or equal to k, and 1 is less than or equal to m.

According to an embodiment of the present disclosure, determining the l number of second-level accounts that need to allocate resources comprises: taking m as an initial value of p, performing the following operations cyclically until respective residual resource values of p number of second-level accounts are all less than an average value obtained by dividing a sum of resource values by p: determining the first total redundant resource value and a sum of residual resource values of the p number of second-level accounts to obtain the sum of the resource values (operation S1101); determining an average value obtained by dividing the sum of the resource values by p (operation S1103); determining second-level accounts whose residual resource value is less than the average value among the p number of second-level accounts, acquiring q number of second-level accounts (operation S1105 and operation S1109), and making p=q (operation S1111). When the respective residual resource values of the p number of second-level accounts are all less than the average value, the p number of second-level accounts are determined as the l number of second-level accounts (operation S1107).

According to an embodiment of the present disclosure, the second instructing module 1707 is specifically for instructing the first data center: when the average value obtained by dividing the sum of the resource values by the 1 is an integer, determining the allocated resource values allocated to respective l number of second-level accounts to be differences between the average value and respective residual resource values of the l number of second-level accounts; or, when the average value obtained by dividing the sum of the resource values and the 1 is not an integer, determining the allocated resource values allocated to respective l number of second-level accounts to be differences between an integer value obtained by rounding down the average value and respective residual resource values of the 1 number of second-level accounts.

According to an embodiment of the present disclosure, the second instructing module 1707 is further for generating a first transaction detail data corresponding to the first total redundant resource value after instructing the first data center to update the total redundant resource value of the first-level account.

According to an embodiment of the present disclosure, successively deducting the 1 number of allocated resource values from the first total redundant resource value comprises: successively performing the following operations until the l number of deduction results are obtained: deducting an i-th allocated resource value from the first total redundant resource value to obtain a second total redundant resource value and an i-th deduction result (operation S1201); and generating a second transaction detail data corresponding to the second total redundant resource value (operation S1203). The i-th deduction result is used to indicate whether the i-th allocated resource value is successfully deducted, and i is a positive integer belonging to [1, 1].

According to an embodiment of the present disclosure, the second instructing module 1707 is further for, after instructing the second data center to send respective redundant resource values of the n number of second-level accounts, performing the following operations: updating the residual resource values of the n number of second-level accounts and generating a third transaction detail data, wherein the third transaction detail data corresponds to updated residual resource values of the n number of second-level accounts; and/or, the second instructing module 1707 is further for generating a fourth transaction detail data after instructing the second data center to update the residual resource values of the k number of second-level accounts, wherein the fourth transaction detail data corresponds to the updated residual resource values of the k number of second-level accounts.

According to the embodiment of the present disclosure, the resource reference value determination module 1701 is specifically for determining the resource reference value of each second-level account in the m number of second-level accounts to be an average value of the m number of residual resource values.

Any number of modules, sub-modules, units, sub-units according to the embodiments of the present disclosure or at least part of the functions thereof may be implemented in one module. Any one or more of the modules, sub-modules, units, sub-units according to the embodiments of the present disclosure may be split into multiple modules for implementation. Any one or more of the modules, sub-modules, units, sub-units according to the embodiments of the present disclosure may be at least partially implemented as hardware circuits, for example, field programmable gate array (FPGA), programmable logic array (PLA), system on chip, system on substrate, system on package, application-specific integrated circuit (ASIC), or implemented as hardware or firmware that integrate or package a circuit in any suitable way, or implemented in any one or a suitable combination of the following three ways: software, hardware, and firmware. Alternatively, one or more of the modules, sub-modules, units, and sub-units according to the embodiments of the present disclosure may be at least partially implemented as a computer program module, and when the computer program module is executed, the corresponding function may be performed.

For example, any number of the resource reference value determination module 1701, the first instructing module 1703, the redundant resource value receiving module 1705, the second instructing module 1707, the preprocessing module 1709, the processing sub-module 1719 and the determination sub-module 1739 can be combined into one module; alternatively, any one of the modules can be split into multiple modules. Alternatively, at least part of the functions of one or more of these modules can be combined with at least part of the functions of other modules, and implemented in one module. According to an embodiment of the present disclosure, at least one of the resource reference value determination module 1701, the first instructing module 1703, the redundant resource value receiving module 1705, the second instructing module 1707, the preprocessing module 1709, the processing sub-module 1719 and the determination sub-module 1739 may be at least partially implemented as hardware circuits, for example, field programmable gate array (FPGA), programmable logic array (PLA), system on chip, system on substrate, system on package, application-specific integrated circuit (ASIC), or implemented as hardware or firmware that integrate or package a circuit in any suitable way, or implemented in any one or a suitable combination of the following three ways: software, hardware, and firmware. Alternatively, at least one of the resource reference value determination module 1701, the first instructing module 1703, the redundant resource value receiving module 1705, the second instructing module 1707, the preprocessing module 1709, the processing sub-module 1719 and the determination sub-module 1739 may be at least partially implemented as a computer program module, and when the computer program module is executed, the corresponding function may be performed.

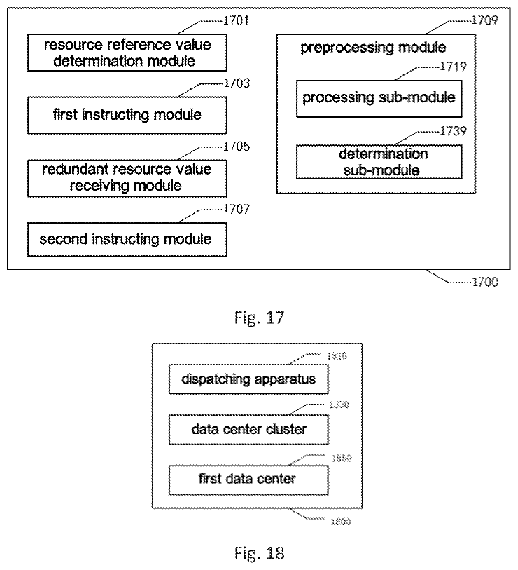

FIG. 18 schematically shows a block diagram of the structure of a transaction data processing system according to an embodiment of the present disclosure.

As shown in FIG. 18, the distributed processing system 1800 of the embodiment of the present disclosure comprises a dispatching apparatus 1810, a data center cluster 1830 and a first data center 1850. The data center cluster 1830 comprises a second data center provided with m number of second-level accounts among the multiple second data centers 730 described in FIG. 8A, which is used to store the resources of the m number of second-level accounts of the same third-party institution. The dispatching apparatus 1810 interacts with the first data center 1850 and the second data center provided with the m number of second-level accounts. The first data center is for storing the redundant resource value of the first-level account.

According to an embodiment of the present disclosure, the dispatching apparatus 1810 may be the dispatching apparatus 720 described in FIG. 8A, and the first data center 1850 may be the first data center 710 described in FIG. 8A. The dispatching apparatus 1810 is configured to perform the operations described in FIGS. 9 to 13 through interaction with the second data center provided with the m number of second-level accounts and the first data center 1850.

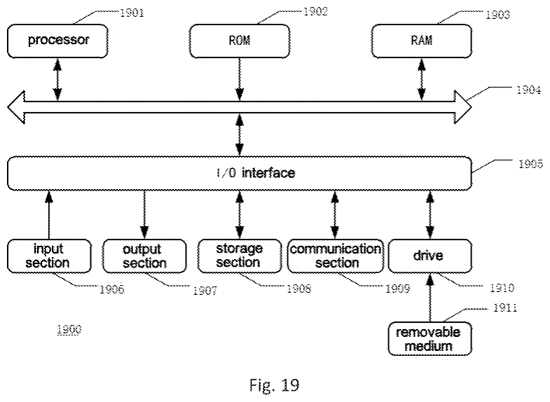

FIG. 19 schematically shows a block diagram of an electronic device suitable for implementing a transaction data processing method according to an embodiment of the present disclosure. The electronic device shown in FIG. 19 is only an example and should not impose any restrictions on the function and application scope of the embodiments of the present disclosure.

As shown in FIG. 19, the electronic device 1900 according to an embodiment of the present disclosure comprises a processor 1901, which performs a variety of appropriate actions and processing according to a program stored in a read only memory (ROM) 1902 or loaded from a storage section 1908 into a random access memory (RAM) 703. The processor 1901 may comprise, for example, a general-purpose microprocessor (for example, a CPU), an instruction set processor and/or a related chipset and/or a special purpose microprocessor (for example, an application specific integrated circuit (ASIC)), and so on. The processor 1901 may also comprise on-board memory for caching purposes. The processor 1901 may comprise a single processing unit or multiple processing units for executing different actions of a method flow according to the embodiments of the present disclosure.

In the RAM 1903, various programs and data necessary for the operation of the electronic device 1900 are stored. The processor 1901, the ROM 1902, and the RAM 1903 are connected to each other through a bus 1904. The processor 1901 executes various operations of the method flow according to the embodiments of the present disclosure by executing programs in the ROM 1902 and/or RAM 1903. It should be noted that the program can also be stored in one or more memories other than the ROM 1902 and the RAM 1903. The processor 1901 may also execute various operations of the method flow according to the embodiments of the present disclosure by executing programs stored in the one or more memories.

According to an embodiment of the present disclosure, the electronic device 1900 may further comprise an input/output (I/O) interface 1905, and the input/output (I/O) interface 1905 is also connected to the bus 1904. The electronic device 1900 may also comprise one or more of the following components connected to the I/O interface 1905: an input section 1906 including a keyboard, a mouse, etc.; an output section 1907 including a cathode ray tube (CRT), a liquid crystal display (LCD), etc. and a speaker, etc.; a storage section 1908 including a hard disk, etc.; and a communication section 1909 including the network interface card such as a LAN card, a modem, etc. The communication section 1909 performs communication processing via a network such as the Internet. The drive 1910 is also connected to the I/O interface 1905 as needed. A removable medium 1911, such as a magnetic disk, an optical disk, a magneto-optical disk, a semiconductor memory, etc., is installed on the drive 1910 as needed, so that the computer program read from it is installed into the storage section 1908 as needed.

According to an embodiment of the present disclosure, the method flow according to the embodiments of the present disclosure may be implemented as a computer software program. For example, an embodiment of the present disclosure includes a computer program product, which includes a computer program carried on a computer-readable storage medium, and the computer program contains program codes for executing the method shown in the flowchart. In such an embodiment, the computer program may be downloaded and installed from the network through the communication section 1909, and/or installed from the removable medium 1911. When the computer program is executed by the processor 1901, the above functions defined in the system of the embodiments of the present disclosure are executed. According to an embodiment of the present disclosure, the systems, devices, devices, modules, units, etc. described above may be implemented by computer program modules.

The present disclosure also provides a computer-readable storage medium. The computer-readable storage medium may be included in the device/apparatus/system described in the above embodiment; or it may exist alone without being assembled into the device/apparatus/system. The computer-readable storage medium carries one or more programs, and when the one or more programs are executed, the method according to the embodiments of the present disclosure is implemented.

According to an embodiment of the present disclosure, the computer-readable storage medium may be a non-volatile computer-readable storage medium. For example, it may include, but not limited to: portable computer disk, hard disk, random access memory (RAM), read-only memory (ROM), erasable programmable read-only memory (EPROM or flash memory), portable compact disk read-only memory (CD-ROM), optical storage device, magnetic storage device, or any suitable combination of the above. In the present disclosure, a computer-readable storage medium may be any tangible medium that contains or stores a program, and the program may be used by or in combination with an instruction execution system, apparatus, or device.

For example, according to an embodiment of the present disclosure, the computer-readable storage medium may include the ROM 1902 and/or the RAM 1903 described above and/or one or more memories other than the ROM 1902 and the RAM 1903.

The present disclosure also provides a data processing system. The data processing system may comprise a target payment institution, a transaction data processing apparatus and a transaction forwarding system.

The transaction data processing apparatus may be the transaction data processing apparatus described in any of the foregoing embodiments, and will not be repeated here.

The transaction forwarding system comprises a transaction system and an account system. The transaction system comprises all data centers created through transaction data processing apparatus for payment institutions. The account system comprises all second-level accounts created through transaction data processing apparatus for payment institutions. In addition, the account system may further comprise the upper-level accounts of all second-level accounts (i.e., the first-level account) and the lower-level accounts (i.e., the third-level account, that is, fund outflow and inflow sub-accounts) of all second-level accounts.

The flowcharts and block diagrams in the accompanying drawings illustrate the architecture, functionality, and operation of possible implementations of systems, methods, and computer program products according to various embodiments of the present disclosure. In this regard, each block in the flowchart or block diagram can represent a module, a program segment, or a part of code, and the above module, program segment, or part of code contains one or more executable instructions for realizing the specified logic functions. It should also be noted that, in some alternative implementations, the functions indicated in the block may also occur in a different order from the order shown in the drawings. For example, two blocks shown in succession can actually be executed substantially in parallel, and they can sometimes be executed in the reverse order, depending on the functions involved. It should also be noted that each block in the block diagram or flowchart, and the combinations of blocks in the block diagram or flowchart, may be implemented by a dedicated hardware-based system that performs the specified functions or operations, or may be implemented by a combination of dedicated hardware and computer instructions.

A person skilled in the art can understand that the features recited in the various embodiments of the present disclosure and/or the claims can be combined or incorporated in various ways, even if such combinations or incorporations are not explicitly recited in the present disclosure. In particular, without departing from the spirit and teachings of the present disclosure, the features recited in the various embodiments of the present disclosure and/or the claims can be combined or incorporated in various ways. All these combinations and/or incorporations fall within the scope of the present disclosure.

The embodiments of the present disclosure have been described above. However, these embodiments are for illustrative purposes only, and are not intended to limit the scope of the present disclosure. Although the respective embodiments are described above, it does not mean that the methods in the respective embodiments cannot be advantageously used in combination. The scope of the present disclosure is defined by the appended claims and their equivalents. Without departing from the scope of the present disclosure, a person skilled in the art can make various substitutions and modifications which should all fall within the scope of the present disclosure.

1. A transaction data processing method, comprising:
creating multiple data centers;
with respect to at least two data centers in the multiple data centers, creating corresponding second-level accounts for a target payment institution respectively, wherein the second-level accounts support resource requirements of any one third-level account corresponding to the target payment institution in the data centers;
determining an available data center in the at least two data centers; and
processing transaction data from the target payment institution by using a second-level account created for the target payment institution with respect to the available data center.

2. The transaction data processing method according to claim 1, further comprising:
creating a corresponding first-level account for the target payment institution, wherein the first-level account is an upper-level account of all second-level accounts created with respect to the target payment institution;
creating an association relationship between the second-level accounts of the target payment institution and the first-level account of the target payment institution to obtain an account system of the target payment institution, wherein the association relationship includes that a resource amount in the first-level account and a resource amount in the second-level account are independent from each other and are mutually transferrable; and
controlling the transaction data to circulate in the account system during processing the transaction data of the target payment institution.

3. The transaction data processing method according to claim 2, wherein controlling the transaction data to circulate in the account system comprises:
when a second-level account of the target payment institution corresponding to an available data center fails, using a second-level account of the target payment institution corresponding to any other available data center to process the transaction data of the target payment institution.

4. The transaction data processing method according to claim 2, wherein controlling the transaction data to circulate in the account system comprises:
when a data center level resource amount of the target payment institution corresponding to an available data center is insufficient, using both a second-level account of the target payment institution corresponding to the available data center and a second-level account of the target payment institution corresponding to any other available data center to process the transaction data of the target payment institution.

5. The transaction data processing method according to claim 1, further comprising:
creating at least one third-level account for each second-level account of the target payment institution.

6. The transaction data processing method according to claim 1, further comprising:
creating transaction routes between different data centers to obtain a corresponding transaction system; and
during processing the transaction data of the target payment institution, when an available data center fails or is busy, using any other available data center in the transaction system to process the transaction data of the target payment institution.

7. (canceled)

8. (canceled)

9. (canceled)

10. (canceled)

11. (canceled)

12. (canceled)

13. The transaction data processing method according to claim 1, wherein the first data center is provided with a first-level account, the second data center is provided with m number of second-level accounts, the first-level account corresponds to the m number of second-level accounts, and the method further comprises:
determining a resource reference value with respect to the m number of second-level accounts according to m number of residual resource values of the m number of second-level accounts;
sending the resource reference value to the second data center to instruct the second data center to determine whether to send a redundant resource value of each second-level account provided therein;
receiving respective redundant resource values of n number of second-level accounts sent by the second data center to obtain n number of redundant resource values;
pushing the n number of redundant resource values to the first data center to instruct the first data center to determine an allocated resource value allocated to k number of second-level accounts in the m number of second-level accounts; and
sending the allocated resource value to the second data center to instruct the second data center to update the residual resource values of the k number of second-level accounts according to the allocated resource value;
where m, n and k are positive integers, n is less than m, and k is less than or equal to m.

14. The method according to claim 13, wherein before determining the resource reference value with respect to the m number of second-level accounts, the method further comprises:
determining whether the m number of residual resource values meet a preset condition; and
when the m number of residual resource values meet the preset condition, determining the resource reference value with respect to the m number of second-level accounts.

15. The method according to claim 14, wherein determining whether the m number of residual resource values meet the preset condition comprises:
determining an actual deviation degree and an actual deviation value of the m number of residual resource values; and
when the actual deviation degree is greater than a preset deviation degree and the actual deviation value is greater than a preset deviation value, determining that the m number of residual resource values meet the preset condition.

16. The method according to claim 14, further comprising:
instructing the second data center to do as follows: update respective residual resource values of the n number of second-level accounts when it is determined to send respective redundant resource values of the n number of second-level accounts; and
instructing the first data center to do as follows: update a total redundant resource value of the first-level account according to the n number of redundant resource values to obtain a first total redundant resource value;
wherein determining the allocated resource value allocated to the k number of second-level accounts in the m number of second-level accounts comprises:
determining l number of second-level accounts that need to allocate resources and l number of allocated resource values allocated to the l number of second-level accounts according to the first total redundant resource value and respective residual resource values of the m number of second-level accounts;
successively deducting the l number of allocated resource values from the first total redundant resource value to obtain l number of deduction results with respect to the l number of second-level accounts; and
determining the second-level account corresponding to a deduction result indicating a successful deduction among the l number of deduction results, thereby acquiring the k number of second-level accounts,
where l is a positive integer, l is greater than or equal to k, and l is less than or equal to m.

17. The method according to claim 16, wherein determining the l number of second-level accounts that need to allocate resources comprises:
taking m as an initial value of p, performing the following operations cyclically until respective residual resource values of p number of second-level accounts are all less than an average value obtained by dividing a sum of resource values by p:
determining the first total redundant resource value and a sum of residual resource values of the p number of second-level accounts to obtain the sum of the resource values;
determining an average value obtained by dividing the sum of the resource values by p; and
determining second-level accounts whose residual resource value is less than the average value among the p number of second-level accounts, to acquire q number of second-level accounts, and making p=q;
wherein when the respective residual resource values of the p number of second-level accounts are all less than the average value, it is determined that the p number of second-level accounts are the l number of second-level accounts, and q is a positive integer less than p.

18. The method according to claim 17, wherein determining the l number of allocated resource values allocated to the l number of second-level accounts comprises:
when the average value obtained by dividing the sum of the resource values by the l is an integer, determining the allocated resource values allocated to respective l number of second-level accounts to be differences between the average value and respective residual resource values of the l number of second-level accounts; or
when the average value obtained by dividing the sum of the resource values and the l is not an integer, determining the allocated resource values allocated to respective l number of second-level accounts to be differences between an integer value obtained by rounding down the average value and respective residual resource values of the l number of second-level accounts.

19. The method according to claim 16, further comprising:
generating a first transaction detail data corresponding to the first total redundant resource value after instructing the first data center to update the total redundant resource value of the first-level account.

20. The method according to claim 19, wherein successively deducting the l number of allocated resource values from the first total redundant resource value comprises:
successively performing the following operations until the l number of deduction results are obtained:
deducting an i-th allocated resource value from the first total redundant resource value to obtain a second total redundant resource value and an i-th deduction result; and
generating a second transaction detail data corresponding to the second total redundant resource value;
wherein the i-th deduction result is used to indicate whether the i-th allocated resource value is successfully deducted, and i is a positive integer belonging to [1, l].

21. The method according to claim 13, further comprising:
after instructing the second data center to send respective redundant resource values of the n number of second-level accounts, performing the following operations: updating the residual resource values of the n number of second-level accounts and generating a third transaction detail data, wherein the third transaction detail data corresponds to updated residual resource values of the n number of second-level accounts; and/or,
generating a fourth transaction detail data after instructing the second data center to update the residual resource values of the k number of second-level accounts, wherein the fourth transaction detail data corresponds to the updated residual resource values of the k number of second-level accounts.

22. The method according to claim 13, wherein determining the resource reference value with respect to the m number of second-level accounts comprises:
determining the resource reference value of each second-level account in the m number of second-level accounts to be an average value of the m number of residual resource values.

23. (canceled)

24. (canceled)

25. (canceled)

26. (canceled)

27. (canceled)

28. (canceled)

29. (canceled)

30. (canceled)

31. An electronic device, comprising:
one or more processors;
a memory for storing one or more programs,
wherein, when the one or more programs are executed by the one or more processors, the one or more processors are caused to implement the transaction data processing method, wherein the transaction data processing method comprises:
creating multiple data centers;
with respect to at least two data centers in the multiple data centers, creating corresponding second-level accounts for a target payment institution respectively, wherein the second-level accounts support resource requirements of any one third-level account corresponding to the target payment institution in the data centers;
determining an available data center in the at least two data centers; and
processing transaction data from the target payment institution by using a second-level account created for the target payment institution with respect to the available data center.

32. A computer readable storage medium having executable instructions stored thereon, wherein when executed by a processor, the instructions causes the processor to implement the transaction data processing method,
wherein the transaction data processing method comprises:
creating multiple data centers;
with respect to at least two data centers in the multiple data centers, creating corresponding second-level accounts for a target payment institution respectively, wherein the second-level accounts support resource requirements of any one third-level account corresponding to the target payment institution in the data centers;
determining an available data center in the at least two data centers; and
processing transaction data from the target payment institution by using a second-level account created for the target payment institution with respect to the available data center.
